(19) United States
(12) Patent Application Publication
(10) Pub. No.: US 2024/0242411 A1
(43) Pub. Date: Jul. 18, 2024

(54) IMAGE PROCESSING METHOD, INTELLIGENT TERMINAL, AND STORAGE MEDIUM

(71) Applicant: SHENZHEN TRANSSION HOLDINGS CO., LTD., Guangdong (CN)

(72) Inventors: Longan XIAO, Guangdong (CN); Guoqiang SHANG, Guangdong (CN); Jianliang LAN, Guangdong (CN)

(73) Assignee: SHENZHEN TRANSSION HOLDINGS CO., LTD., Guangdong (CN)

(21) Appl. No.: 18/614,714

(22) Filed: Mar. 24, 2024

Related U.S. Application Data
(63) Continuation of application No. PCT/CN2021/122430, filed on Sep. 30, 2021.

(51) Int. Cl. G06T 11/60; G06T 7/90

(52) U.S. Cl. CPC G06T 11/60; G06T 7/90

(57) ABSTRACT

The present application provides an image processing method, an intelligent terminal, and a storage medium. The processing method is applied to a processing device, and includes the following steps: first, acquiring an image data stream when acquiring a target image; and processing the image data stream according to an image processing instruction, determining or generating corresponding image processing information, and obtaining the target image. In this way, the target image can be quickly acquired, thereby effectively improving acquisition efficiency of the target image.

### CROSS-REFERENCE TO RELATED APPLICATIONS

This application is a continuation of International Application No. PCT/CN2021/122430, filed on Sep. 30, 2021, the disclosure of which is hereby incorporated by reference in its entirety.

### BACKGROUND

### Technical Field

The present application relates to the field of image processing technology and, in particular, to an image processing method, an intelligent terminal and a storage medium.

Computational photography is a comprehensive technology to create new photographic equipment and applications with use of an image processing algorithm in combination with sensors, modern optics and other technologies, and can create a novel image application by means of software and hardware coordination.

Taking a computational photography scenario as an example, when acquiring an image of a shooting picture by means of computational photography, the inventors find at least the following problem exists during conception and implementation of the present application: how to quickly acquire an image of a shooting picture to improve acquisition efficiency of the image is a problem to be solved urgently in the art.

The foregoing description is intended to provide general background information and does not necessarily constitute a prior art.

### SUMMARY

In view of the above-mentioned technical problem, the present application provides an image processing method, an intelligent terminal and a storage medium, according to which a captured image can be quickly acquired to improve acquisition efficiency of an image.

To address the above-mentioned technical problem, the present application provides an image processing method which, in an implementation, can be applied to an intelligent terminal and may include:
S1: acquiring an image data stream;
S2: processing the image data stream according to an image processing instruction, determining or generating corresponding image processing information, and obtaining a target image.

In an implementation, the determining or generating the corresponding image processing information, and obtaining the target image includes at least one of the following:
determining or generating the corresponding image processing information and obtaining the target image simultaneously;
determining or generating the corresponding image processing information firstly, and then obtaining the target image;
obtaining the target image firstly, and then determining or generating the corresponding image processing information.

In an implementation, the image data stream includes image data, and S2 includes:

processing the image data according to the image processing instruction to obtain target image data, and determining or generating the corresponding image processing information.

In an implementation, the image data stream includes basic image information, and S2 includes:
determining whether the processing causes a change in the basic image information;
if it is determined that a change exists in the basic image information, determining or generating target basic image information, updating the image data stream based on the target basic image information, the target image data and the image processing information, to obtain a target image data stream, and obtaining the target image according to the target image data stream; and/or
if it is determined that no change exists in the basic image information, updating the image data stream based on the target image data and the image processing information, to obtain a target image data stream, and obtaining the target image according to the target image data stream.

In an implementation, the image processing information includes at least one of the following features:
the image processing information, in the target image data stream, is located between the target basic image information and the target image data;
the image processing information, in the target image data stream, is located between the basic image information and the target image data.

In an implementation, the image data stream further includes an identifier of imaging information, where the updating the image data stream based on the target basic image information, the target image data and the image processing information includes:
determining whether the processing causes a change in the imaging information;
if it is determined that a change exists in the imaging information, determining or generating target imaging information, and updating the image data stream based on the target basic image information, the target imaging information, the target image data and the image processing information; and/or
if it is determined that no change exists in the imaging information, updating the image data stream based on the target basic image information, the target image data and the image processing information.

In an implementation, the target imaging information and the image processing information, in the target image data stream, are located between the target basic image information and the target image data, and the target imaging information is located before the image processing information;

both the imaging information and the image processing information, in the target image data stream, are located between the target basic image information and the target image data, and the imaging information is located before the image processing information.

In an implementation, the image processing method further includes:

if the image data stream includes original image processing information, adding the image processing information to the original image processing information in the image data stream.

In an implementation, the original image processing information includes a processing-reversible identifier, and the image processing method further includes:

if the processing-reversible identifier indicates reversible processing, eliminating the image data from the target image data stream.

In an implementation, the basic image information includes at least one of the following:

a length of the basic image information, a type identifier of the image data, a length of the image data, a width of the image data, a color space of the image data, a bit width of the image data, or a storage mode of the image data.

In an implementation, the image processing information includes at least one of the following:

a length of the image processing information, a processing identifier, a processing-reversible identifier, processing description type information, a prior-to-processing data preservation identifier, or the image data.

The present application further provides an image processing method which, In an implementation, can be applied in an intelligent terminal and may include:
S10: acquiring an image data stream, where the image data stream includes image data and basic image information;
S20: processing the image data according to an image processing instruction, and determining or generating target basic image information, to update the image data stream, and obtaining a target image.

In an implementation, S20 includes:
processing the image data according to the image processing instruction to obtain target image data, and determining or generating corresponding image processing information;
updating the image data stream based on the target basic image information, the target image data and the image processing information, to obtain a target image data stream, and obtaining the target image according to the target image data stream.

In an implementation, if the image data stream further includes an identifier of imaging information, where the updating the image data stream based on the target basic image information, the target image data and the image processing information includes:
determining whether the processing causes a change in the imaging information;
if it is determined that a change exists in the imaging information, determining or generating target imaging information, and updating the image data stream based on the target basic image information, the target imaging information, the target image data and the image processing information; and/or
if it is determined that no change exists in the imaging information, updating the image data stream based on the target basic image information, the target image data and the image processing information.

In an implementation, the target imaging information and the image processing information, in the target image data stream, are located between the target basic image information and the target image data, and the target imaging information is located before the image processing information;

both the imaging information and the image processing information, in the target image data stream, are located between the target basic image information and the target image data, and the imaging information is located before the image processing information.

In an implementation, the imaging information includes at least one of the following:

a length of the imaging information, a shutter time of an imaging device, photo-sensibility of the imaging device, an aperture of the imaging device, a focal length of the imaging device, gyroscope information of the imaging device, an acceleration of the imaging device, geographic location information of the imaging device, or image rotation angle information of the imaging device.

The present application further provides an image processing apparatus. The image processing apparatus may include:
an acquiring unit, configured to acquire an image data stream; and
a processing unit, configured to process the image data stream according to an image processing instruction, determine or generate corresponding image processing information, and obtain a target image.

In an implementation, the processing unit is specifically configured to perform at least one of the following:
determining or generating the corresponding image processing information and obtaining the target image simultaneously;
determining or generating the corresponding image processing information firstly, and then obtaining the target image;
obtaining the target image firstly, and then determining or generating the corresponding image processing information.

In an implementation, the image data stream includes image data;

the processing unit is specifically configured to process the image data according to the image processing instruction to obtain target image data, and determine or generate the corresponding image processing information.

In an implementation, the image data stream includes basic image information;

the processing unit is specifically configured to determine whether the processing causes a change in the basic image information; if it is determined that a change exists in the basic image information, determine or generate target basic image information, update the image data stream based on the target basic image information, the target image data and the image processing information, to obtain a target image data stream, and obtain the target image according to the target image data stream; and/or if it is determined that no change exists in the basic image information, update the image data stream based on the target image data and the image processing information, to obtain a target image data stream, and obtain the target image according to the target image data stream.

In an implementation, the image processing information includes at least one of the following features:
the image processing information, in the target image data stream, is located between the target basic image information and the target image data;
the image processing information, in the target image data stream, is located between the basic image information and the target image data.

In an implementation, the image data stream further includes an identifier of imaging information;

the processing unit is specifically configured to determine whether the processing causes a change in the imaging information; if it is determined that a change exists in the imaging information, determine or generate target imaging information, and update the image data stream based on the target basic image information, the target imaging information, the target image data and the image processing information; and/or if it is determined that no change exists in the imaging information, update the image data stream based on the target basic image information, the target image data and the image processing information.

In an implementation, the target imaging information and the image processing information, in the target image data stream, are located between the target basic image information and the target image data, and the target imaging information is located before the image processing information;

both the imaging information and the image processing information, in the target image data stream, are located between the target basic image information and the target image data, and the imaging information is located before the image processing information.

In an implementation, the image processing apparatus further includes an adding unit;

the adding unit is configured to: if the image data stream includes original image processing information, add the image processing information to the original image processing information in the image data stream.

In an implementation, the original image processing information includes a processing-reversible identifier, and the image processing apparatus further includes an eliminating unit.

The eliminating unit is configured to: if the processing-reversible identifier indicates reversible processing, eliminate the image data from the target image data stream.

In an implementation, the basic image information includes at least one of the following:

a length of the basic image information, a type identifier of the image data, a length of the image data, a width of the image data, a color space of the image data, a bit width of the image data, or a storage mode of the image data.

In an implementation, the image processing information includes at least one of the following:

a length of the image processing information, a processing identifier, a processing-reversible identifier, processing description type information, a prior-to-processing data preservation identifier, or the image data.

An embodiment of the present application further provides an image processing apparatus. The image processing apparatus may include:
an acquiring unit, configured to acquire an image data stream, where the image data stream includes image data and basic image information; and
a processing unit, configured to process the image data according to an image processing instruction, and determine or generate target basic image information, to update the image data stream, and obtain a target image.

In an implementation, the processing unit is specifically configured to: process the image data according to the image processing instruction to obtain target image data, and determine or generate corresponding image processing information; update the image data stream based on the target basic image information, the target image data and the image processing information, to obtain a target image data stream, and obtain the target image according to the target image data stream.

In an implementation, if the image data stream further includes an identifier of imaging information;

the processing unit is specifically configured to determine whether the processing causes a change in the imaging information; if it is determined that a change exists in the imaging information, determine or generate target imaging information, and update the image data stream based on the target basic image information, the target imaging information, the target image data and the image processing information; and/or if it is determined that no change exists in the imaging information, update the image data stream based on the target basic image information, the target image data and the image processing information.

In an implementation, the target imaging information and the image processing information, in the target image data stream, are located between the target basic image information and the target image data, and the target imaging information is located before the image processing information;

both the imaging information and the image processing information, in the target image data stream, are located between the target basic image information and the target image data, and the imaging information is located before the image processing information.

In an implementation, the imaging information includes at least one of the following:

a length of the imaging information, a shutter time of an imaging device, photo-sensibility of the imaging device, an aperture of the imaging device, a focal length of the imaging device, gyroscope information of the imaging device, an acceleration of the imaging device, geographic location information of the imaging device, or image rotation angle information of the imaging device.

The present application further provides an intelligent terminal. The intelligent terminal includes a memory and a processor, where a program for processing image data is stored in the memory, and the program for processing the image data, when executed by the processor, implements steps of any image processing method as described above.

The present application further provides a readable storage medium on which a computer program is stored, where the computer program, when executed by a processor, implements steps of any image processing method as described above.

An embodiment of the present application further provides a computer program product. The computer program product includes a computer program, where the computer program, when executed, implements steps of any image processing method as described above.

As described above, according to the image processing method provided in the present application, it is possible to first acquire an image data stream when acquiring a target image; and process the image data stream according to an image processing instruction, determine or generate corresponding image processing information, and obtain the target image. In this way, the target image can be quickly acquired, thereby effectively improving the acquisition efficiency of the target image.

### BRIEF DESCRIPTION OF THE DRAWINGS

The drawings herein are incorporated into the specification and form a part thereof, showing embodiments consistent with the present application, and are used together with the specification to explain the principles of the present application. In order to more clearly explain technical solutions in the embodiments of the present application, a brief introduction will be made hereunder to the drawings used for description of the embodiments. Apparently, for persons of ordinary skill in the art, other drawings can be derived based on these drawings without creative effort.

FIG. 1 is a schematic diagram of a hardware structure of an intelligent terminal implementing various embodiments of the present application.

FIG. 2 is an architecture diagram of a communication network system according to an embodiment of the present application.

FIG. 3 is a flowchart of an image processing method according to an embodiment of the present application.

FIG. 4 is a schematic diagram of a framework for acquiring a target image by a capturing apparatus according to an embodiment of the present application.

FIG. 5 is a flowchart of another image processing method according to an embodiment of the present application.

FIGS. 6A-6B are flowcharts of yet another image processing method according to an embodiment of the present application.

FIG. 7 is a flowchart of an image processing method according to an embodiment of the present application.

FIG. 8 is a flowchart of another image processing method according to an embodiment of the present application.

FIGS. 9A-9B are flowcharts of yet another image processing method according to an embodiment of the present application.

FIG. 10 is a schematic structural diagram of an image processing apparatus according to an embodiment of the present application.

FIG. 11 is a schematic structural diagram of another image processing apparatus according to an embodiment of the present application.

Implementation of objectives, functional features and advantages of the present application will be further described with reference to the drawings in combination with the embodiments. The embodiments defined in the present application have been shown through the above-mentioned drawings and will be described in more detail hereinafter. These drawings and textual descriptions are not intended to limit scope of conceptions of the present application in any way, but to explain the concepts of the present application to those skilled in the art with reference to specific embodiments.

### DESCRIPTION OF THE EMBODIMENTS

Herein, exemplary embodiments will be described in detail, and examples thereof are identified in the drawings. When the following description involves the drawings, unless otherwise indicated, same numbers in different drawings represent same or similar elements.

Implementations described in the following exemplary embodiments do not represent all implementations consistent with the present application. On the contrary, they are merely examples of apparatuses and methods consistent with some aspects of the present application as detailed in the appended claims.

It should be illustrated that herein the term “include”, “comprise” or any other variation thereof is intended to cover non-exclusive inclusion, so that a process, a method, an article or an apparatus including a series of elements includes not only those elements, but also other elements not explicitly listed, or elements inherent to such process, method, article or apparatus. Without further restrictions, an element defined by the statement “including a . . . ” does not exclude existence of other identical elements in a process, a method, an article or an apparatus including the element. In addition, components, features and elements with the same name in different embodiments of the present application may have the same meaning or different meanings, and a specific meaning thereof needs to be determined by an interpretation thereof in a specific embodiment or by a further combination with the context in the specific embodiment.

It should be understood that although terms such as first, second, third, etc. may be used herein to describe various information, such information should not be limited to these terms. These terms are only used to distinguish the same type of information from each other. For example, without departing from the scope of the present application, first information may also be referred to as second information, similarly, the second information may also be referred to as the first information. Depending on the context, the word “if” as used herein may be interpreted as “at the time of” or “when” or “in response to determining”. Further, as used herein, singular forms “a”, “one” and “the” are intended to include plural forms, unless indicated in the context to the contrary. It should be further understood that the terms “include” and “comprise” indicate existence of a described feature, step, operation, element, component, item, type, and/or group, but do not exclude existence, occurrence or addition of one or more additional features, steps, operations, elements, components, items, types, and/or groups. The terms “or”, “and/or”, “including at least one of the following” used in the present application may be interpreted as inclusive or mean any one or any combination. For example, “including at least one of the following: A, B, and C” means “any of the following: A; B; C; A and B; A and C; B and C; A and B and C”; for another example, “A, B or C” or “A, B and/or C” means “any of the following: A; B; C; A and B; A and C; B and C; A and B and C”. Exceptions to the definition may occur only when combinations of components, functions, steps, or operations are inherently exclusive to each other in some ways.

It should be understood that although various steps in the flow diagrams according to the embodiments of the present application are displayed in sequence as indicated by arrows, these steps are not necessarily performed in sequence as indicated by the arrows. Unless explicitly stated herein, there is no strict order restriction on the execution of these steps, which may be executed in other orders. Moreover, at least part of the steps in the drawings may include a plurality of sub-steps or a plurality of stages. These sub-steps or stages are not necessarily executed at the same time instant, but may be executed at different time instants; and execution sequence thereof is not necessarily sequential. Instead, these sub-steps or stages may be performed with other steps or with at least part of sub-steps or stages of other steps in turn or alternately.

Depending on the context, the words “if” and “in a case that” as used herein may be interpreted as “at the time of”, “when”, “in response to determining”, or “in response to detecting”. Similarly, depending on the context, the phrase “if it is determined” or “if it is detected (a stated condition or event)” may be interpreted as “at the time of determining” or “in response to determining”, or “at the time of detecting (the stated condition or event)” or “in response to detecting (the stated condition or event)”.

It should be illustrated that herein, step numbers such as S301 and S302 are adopted for the purpose of more clearly and briefly expressing the corresponding contents, which do not constitute a substantive limitation in sequence. During specific implementation, those skilled in the art may execute S302 first and then S301, which should fall within the protection scope of the present application.

It should be understood that the specific embodiments described herein are only used to explain the present application and are not used to limit the present application.

In the subsequent description, a suffix such as “module”, “component” or “unit” that is used to represent an element is used merely to facilitate the explanation of the present application, which has no specific meaning per se. Therefore, “module”, “component” or “unit” can be used interchangeably.

An intelligent terminal may be implemented in various forms. For example, the intelligent terminal described in the present application may include: an intelligent terminal such as a mobile phone, a tablet computer, a laptop, a handheld computer, a personal digital assistant (PDA), a portable media player (PMP), a navigation apparatus, a wearable device, a smart bracelet or a pedometer; and a fixed terminal such as a digital TV, a desktop computer.

The following description will take the intelligent terminal as an example. Those skilled in the art will understand that the construction according to the embodiments of the present application may also be applied to a fixed type of terminal, in addition to the elements specially used for mobile purposes.

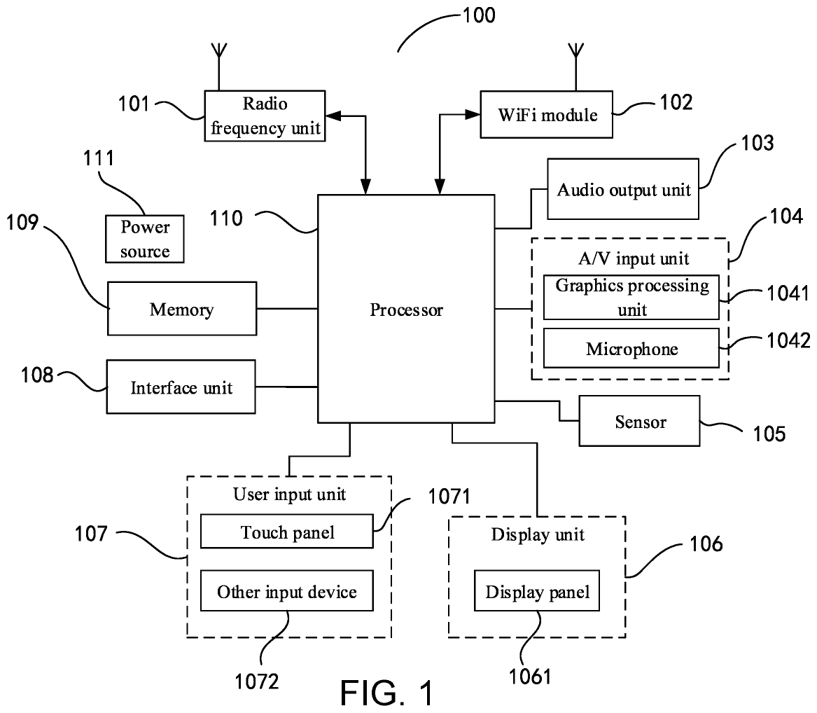

Reference is made to FIG. 1, which is a schematic diagram of a hardware structure of an intelligent terminal implementing various embodiments of the present application. The intelligent terminal 100 may include components such as: an RF (Radio Frequency) unit 101, a WiFi module 102, an audio output unit 103, an A/V (audio/video) input unit 104, a sensor 105, a display unit 106, a user input unit 107, an interface unit 108, a memory 109, a processor 110, a power source 111, etc. Those skilled in the art may understand that the intelligent terminal structure shown in FIG. 1 does not constitute a limitation on the intelligent terminal, and the intelligent terminal may include more or fewer components than shown in the drawings, or a combination of some components, or a different arrangement of components.

Various components of the intelligent terminal will be described in detail hereunder in combination with FIG. 1.

The radio frequency unit 101 can be used for signal reception and transmission during information transceiving or calling, specifically, for processing by the processor 110 after reception of downlink information from a base station; and in addition, for transmission of uplink data to the base station. Generally, the radio frequency unit 101 includes, but is not limited to, an antenna, at least one amplifier, a transceiver, a coupler, a low noise amplifier, a duplexer, etc. In addition, the radio frequency unit 101 may further communicate with a network and other devices through wireless communication. Any communication standard or protocol may be used in the above-mentioned wireless communication, including but not limited to GSM (Global System of Mobile communication), GPRS (General Packet Radio Service), CDMA2000 (Code Division Multiple Access 2000), WCDMA (Wideband Code Division Multiple Access), TD-SCDMA (Time Division-Synchronous Code Division Multiple Access), FDD-LTE (Frequency Division Duplexing-Long Term Evolution), TDD-LTE (Time Division Duplexing-Long Term Evolution) and 5G, etc.

WiFi is a short-range wireless transmission technology. The intelligent terminal can assist a user in transmitting and receiving e-mails, browsing web pages and accessing streaming media through the WiFi module 102. It provides the user with wireless broadband Internet access. Although FIG. 1 shows the WiFi module 102, it can be understood that the WiFi module 102 does not belong to a necessary composition of the intelligent terminal, and may be omitted as needed without changing essence of the present application.

The audio output unit 103 may convert audio data received by the radio frequency unit 101 or the WiFi module 102 or stored in the memory 109 into an audio signal and output it as a sound when the intelligent terminal 100 is in a call signal receiving mode, a call mode, a recording mode, a voice recognition mode, a broadcast receiving mode, etc. Moreover, the audio output unit 103 may also provide audio output related to specific functions performed by the intelligent terminal 100 (e.g., call signal reception sound, message reception sound, etc.). The audio output unit 103 may include a speaker, a buzzer, etc.

The A/V input unit 104 is configured to receive audio or video signals. The A/V input unit 104 may include a graphics processing unit (GPU) 1041 and a microphone 1042. The graphics processing unit 1041 processes image data of a static image or a video obtained by an image capture apparatus (e.g., a camera) in a video capturing mode or an image capturing mode. A processed image frame may be displayed on the display unit 106. The image frame processed by the graphics processing unit 1041 may be stored in the memory 109 (or other storage medium) or transmitted via the radio frequency unit 101 or the WiFi module 102. The microphone 1042 may receive sound (audio data) in a phone call mode, a recording mode, a voice recognition mode and other operating modes, and can process such sound as audio data. When in the phone call mode, processed audio (voice) data can be output after a conversion into a format available for transmission to a mobile communication base station via the radio frequency unit 101. The microphone 1042 may implement various types of noise cancellation (or suppression) algorithms to cancel (or suppress) noise or interference generated during reception and transmission of audio signals.

The intelligent terminal 100 further includes at least one sensor 105, for example, an optical sensor, a motion sensor, and other sensors. In an implementation, the optical sensor includes an ambient light sensor and a proximity sensor. In an implementation, the ambient light sensor may adjust brightness of a display panel 1061 according to luminosity of ambient light, and the proximity sensor may turn off the display panel 1061 and/or backlight when the intelligent terminal 100 is moved to an ear. As a kind of motion sensor, an accelerometer sensor can detect magnitudes of accelerations in respective directions (usually three axes), and detect a magnitude and a direction of gravity when being at rest, and the accelerometer sensor can be used in applications for identifying postures of a mobile phone (for example, landscape and portrait orientations switching, related games, magnetometer posture calibration), vibration recognition related functions (such as a pedometer, tapping), etc.; as for other sensors such as a fingerprint sensor, a pressure sensor, an iris sensor, a molecular sensor, a gyroscope, a barometer, a hygrometer, a thermometer and an infrared sensor, which may be further configured in a mobile phone, details thereof will not be described herein.

The display unit 106 is configured to display information input by a user or information provided to the user. The display unit 106 may include the display panel 1061, which may be configured in a form of a liquid crystal display (LCD), an organic light-emitting diode (OLED), etc.

The user input unit 107 may be configured to receive input numeric or character information, and generate key signal input related to user settings and function control of the intelligent terminal. In an implementation, the user input unit 107 may include a touch panel 1071 and other input device 1072. The touch panel 1071, also known as a touch screen, can collect the user's touch operation on or near the touch panel 1071 (for example, the user's operation on or near the touch panel 1071 using any suitable object or accessory, such as a finger, a stylus, etc.), and drive a corresponding connection apparatus according to a preset program. The touch panel 1071 may include two parts: a touch detection apparatus and a touch controller. In an implementation, the touch detection apparatus detects a touch orientation of the user and detects a signal brought about by the touch operation and transmits the signal to the touch controller; and the touch controller receives touch information from the touch detection apparatus and converts it into contact coordinates which are then transmitted to the processor 110, and is able to receive commands transmitted by the processor 110 and execute the commands. In addition, the touch panel 1071 may be implemented in various types such as resistive, capacitive, infrared, and surface acoustic wave. In addition to the touch panel 1071, the user input unit 107 may further include the other input device 1072. In an implementation, the other input device 1072 may include but is not limited to one or more of a physical keyboard, a function key (for example, a volume control key, a switch key, etc.), a trackball, a mouse, a joystick, etc., which is not specifically limited here.

In an implementation, the touch panel 1071 may cover the display panel 1061, and when detecting a touch operation on or near the touch panel 1071, the touch panel 1071 transmits it to the processor 110 to determine a type of a touch event, and the processor 110 subsequently provides a corresponding visual output on the display panel 1061 based on the type of the touch event. Although in FIG. 1, the touch panel 1071 and the display panel 1061 are configured as two independent components to enable input and output functions of the intelligent terminal, in some embodiments, the touch panel 1071 and the display panel 1061 may be integrated to enable the input and output functions of the intelligent terminal, which is not specifically limited herein.

The interface unit 108 serves as an interface through which at least one external apparatus can be connected to the intelligent terminal 100. For example, the external apparatus may include a wired or wireless headphone port, an external power (or battery charger) port, a wired or wireless data port, a memory card port, a port for connecting an apparatus with an identification module, an audio input/output (I/O) port, a video I/O port, an earphone port, etc. The interface unit 108 may be configured to receive input (e.g., data information, power, etc.) from the external apparatus and transmit the received input to one or more elements in the intelligent terminal 100 or may be configured to transmit data between the intelligent terminal 100 and the external apparatus.

The memory 109 may be configured to store a software program and various data. The memory 109 may mainly include a program storage area and a data storage area. In an implementation, the program storage area may store an operating system, an application program required for at least one function (for example, a sound playing function, an image playing function, etc.), etc.; and the data storage area may store data created according to the use of the mobile phone (for example, audio data, phone book, etc.), etc. In addition, the memory 109 may include a high-speed random access memory, and may further include a non-transitory memory, for example, at least one magnetic disk storage device, and a flash memory device, or other volatile solid-state storage device.

The processor 110 is a control center of the intelligent terminal using various interfaces and lines to connect various parts of the entire intelligent terminal, and by running or executing software programs and/or modules stored in the memory 109, and calling data stored in the memory 109, executes various functions of the intelligent terminal and processes data, so as to perform overall monitoring on the intelligent terminal. The processor 110 may include one or more processing units; in an implementation, the processor 110 may integrate an application processor and a modem processor. In an implementation, the application processor mainly processes an operating system, a user interface, and an application program, etc., and the modem processor mainly processes wireless communication. It can be understood that the above-mentioned modem processor may not be integrated into the processor 110.

The intelligent terminal 100 may further include a power source 111 (for example, a battery) that supplies power to the various components. In an implementation, the power source 111 may be logically connected to the processor 110 through a power management system, so that functions such as charging and discharging management, and power consumption management are implemented through the power management system.

Although not shown in FIG. 1, the intelligent terminal 100 may further include a Bluetooth module, etc., which will not be described herein.

In order to facilitate comprehension of the embodiments of the present application, the communication network system on which the intelligent terminal of the present application is based will be described hereinafter.

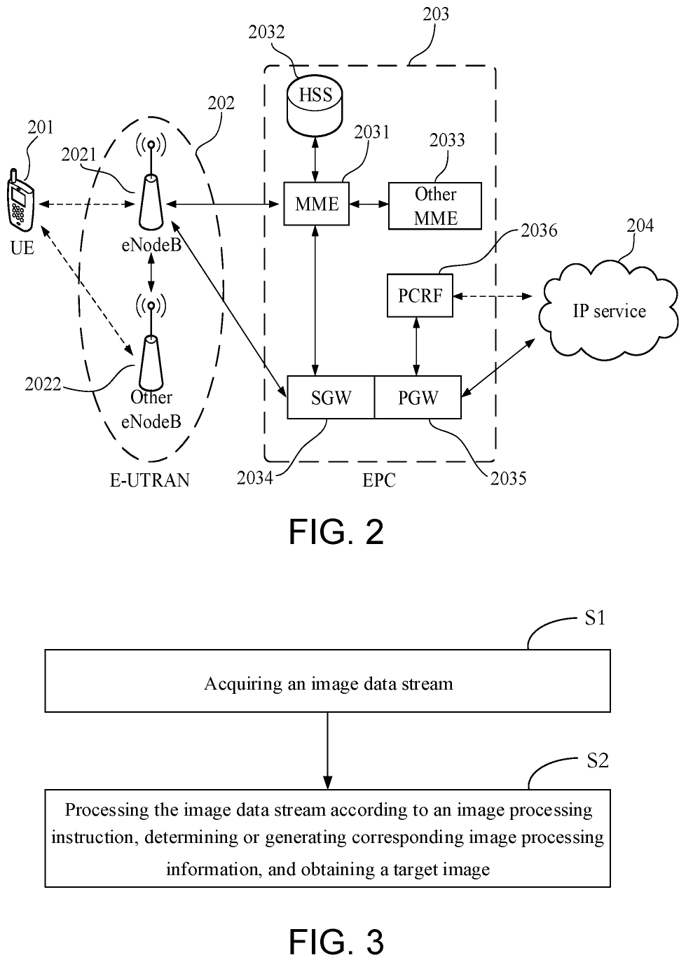

Reference is made to FIG. 2, which is an architecture diagram of a communication network system according to an embodiment of the present application. The communication network system is an LTE system in the general mobile communication technology. The LTE system includes UE (User Equipment) 201, an E-UTRAN (Evolved UMTS Terrestrial Radio Access Network) 202, an EPC (Evolved Packet Core) 203 and an IP service 204 of an operator, which are connected in a communication way subsequently.

In an implementation, the UE 201 may be the above-mentioned terminal 100, which is not described herein.

The E-UTRAN 202 includes an eNodeB 2021 and other eNodeB 2022, etc. In an implementation, the eNodeB 2021 may be connected to the other eNodeB 2022 through backhaul (for example, an X2 interface), the eNodeB 2021 is connected to the EPC 203, and the eNodeB 2021 may provide an access to EPC 203 for the UE 201.

The EPC 203 may include an MME (Mobility Management Entity) 2031, an HSS (Home Subscriber Server) 2032, other MME 2033, an SGW (Serving Gate Way) 2034, a PGW (PDN Gate Way, packet data network gate way) 2035 and a PCRF (Policy and Charging Rules Function) 2036, etc. In an implementation, the MME 2031 is a control node that handles signaling between the UE 201 and the EPC 203, providing bearer and connection management. The HSS 2032 is configured to provide some registers to manage functions such as a home location register (not shown in the drawing), and save some user-specific information about service characteristics, data rates, etc. All user data can be transmitted through the SGW 2034. The PGW 2035 can provide IP address allocation and other functions for the UE 201. The PCRF 2036 is a policy and charging control strategy decision point for traffic data flows and IP bearer resources, and selects and provides available policy and charging control decisions for a policy and charging enforcement function unit (not shown in the drawing).

The IP service 204 may include Internet, an intranet, an IMS (IP Multimedia Subsystem) or other IP services, etc.

Although the above introduction takes the LTE system as an example, those skilled in the art should know that the present application is not only applicable to the LTE system, but also can be applied to other wireless communication systems, for example, GSM, CDMA2000, WCDMA, TD-SCDMA, and new network systems in the future (e.g., 5G), etc., which are not limited herein.

The image processing method provided in the embodiments of the present application can be applied to an image capturing scenario, such as a computational photography scenario. Taking the computational photography scenario as an example, when acquiring an image of a shooting picture by means of computational photography, the inventors find at least the following problem exists: how to quickly acquire an image of a shooting picture to improve acquisition efficiency of the image is a problem to be solved urgently in the art. To address the problem, an embodiment of the present application provides an image processing method, and embodiments of the present application are proposed based on the hardware structure of the intelligent terminal and on the communication network system. The image processing method provided in the present application will be described hereunder in detail with specific embodiments. Understandably, the following specific embodiments can be combined with each other, and for the same or similar concepts or processes, repetitive description will not be made in some embodiments.

### Embodiment 1

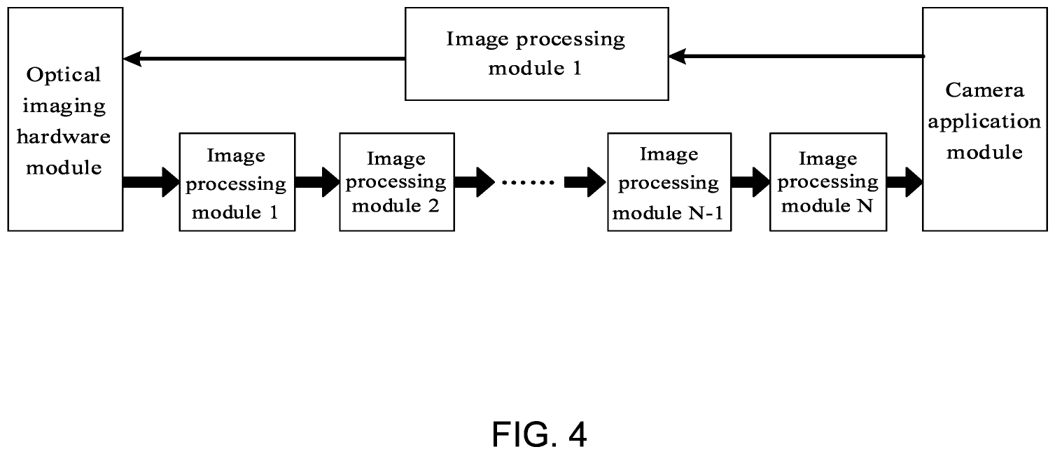

FIG. 3 is a flowchart of an image processing method according to an embodiment of the present application. The image processing method may be performed by software and/or a hardware apparatus. For example, the hardware apparatus can be an image processing apparatus, and the image processing apparatus can be an intelligent terminal. In an implementation, reference is made to FIG. 3, where the image processing method may include the following.

S1: acquiring an image data stream.

In an implementation, when acquiring the image data stream: an image data stream transmitted by an optical imaging hardware module of a capturing apparatus can be received; an image data stream transmitted by another image processing module of the capturing apparatus may also be received. Specific settings are possible according to actual requirements. Here, a manner for acquiring the image data stream is not specifically limited in the embodiments of the present application.

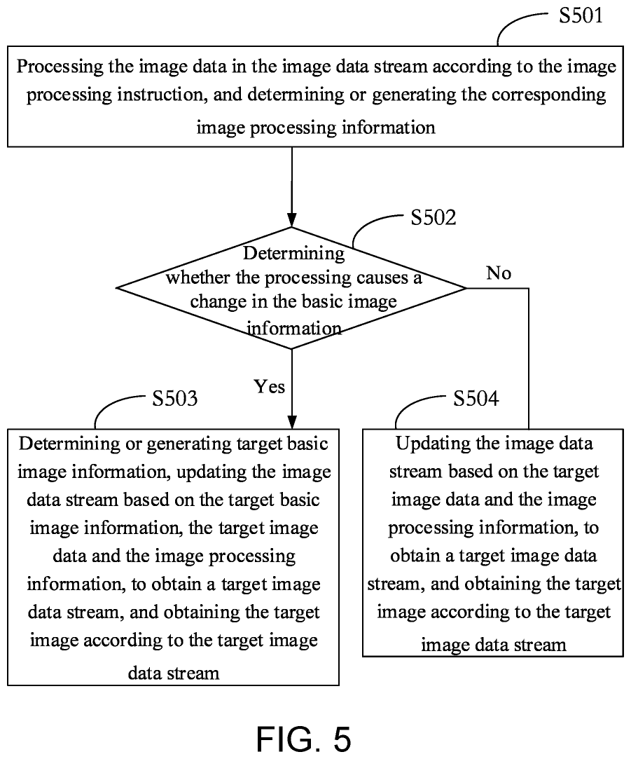

In an implementation, reference may be made to FIG. 4, which is a schematic diagram of a framework for acquiring a target image by a capturing apparatus according to an embodiment of the present application. As can be seen in conjunction with FIG. 4, the capturing apparatus may include an optical imaging hardware module, at least one image processing module, a camera application module and an image control module (not shown in the drawing), to acquire the target image through the optical imaging hardware module, the at least one image processing module, the camera application module and the image control module. In an implementation, the at least one image processing module may be respectively denoted as an image processing module 1, an image processing module 2, . . . , an image processing module N−1, and an image processing module N.

In an implementation, the optical imaging hardware module mainly includes a camera module, such as a photosensitive chip, a lens, a focusing motor and an optical image stabilization (OIS) device, etc., and is additionally provided with an imaging assistive device, such as a flash lamp device and a color temperature sensor, etc.; the image processing module is mainly configured to process code stream data output by camera hardware, and is divided into variety of image processing modules according to different functions or types of code streams to be processed, for example, an image processing module for performing RAW domain noise reduction processing, an image processing module for performing low-light enhancement processing, an image processing module for performing a high dynamic range (HDR) image composition processing, and the like. The camera application module is mainly configured to implement some image-related applications, for example, photo capturing, video recording, video calling, etc. The image control module is mainly configured to set and control the optical imaging hardware module according to output requirements of the camera application module, so that the optical imaging hardware module can collect an image data stream of a shooting picture as desired.

After the image data stream is acquired, processing is performed on the image data stream according to an image processing instruction, corresponding image processing information is determined or generated, and a target image is obtained, that is, S2 in the following description is executed.

S2: processing the image data stream according to an image processing instruction, determining or generating corresponding image processing information, and obtaining a target image.

In an implementation, the image processing instruction may be an image processing instruction generated based on an image processing requirement, or may be a preset image processing instruction. Specific settings are possible according to actual requirements, which here are not specifically limited in the embodiments of the present application.

In an implementation, the processing the image data stream according to the image processing instruction may include, but is not limited to, RAW domain noise reduction processing, low-light enhancement processing, HDR composition processing and the like, which may be specifically set according to actual requirements.

It should be illustrated that in the embodiments of the present application: when performing the RAW domain noise reduction processing on the image data stream according to the image processing instruction, reference may be made to related description of the RAW domain noise reduction processing in the prior art. When performing the low-light enhancement processing on the image data stream according to the image processing instruction, reference may also be made to related description of the low-light enhancement processing in the prior art; and when performing the HDR composition processing on the image data stream according to the image processing instruction, reference may be made to related description of the HDR composition processing in the prior art. Here, details will not be described again in the embodiments of the present application.

After the image data stream is processed according to the image processing instruction, corresponding image processing information may be determined or generated in addition to obtaining a corresponding target image. The image processing information may be interpreted as processing information generated based on a present processing operation, mainly used for describing the present processing operation. In this way, the image processing information is determined or generated, so that the present processing related operation can be learnt subsequently according to the image processing information, providing a query basis for subsequent image data processing.

In an implementation, the image processing information may include at least one of a length of the image processing information, a processing identifier, a processing-reversible identifier, processing description type information, a prior-to-processing data preservation identifier or the image data, which may be specifically set according to actual requirements.

In an implementation, the length of the image processing information is used for identifying an overall length of an image processing information field; the processing identifier is used for identifying one-time image processing information; the processing-reversible identifier is used for identifying whether present image processing is reversible processing; the processing description type information is used for identifying a type description of the present image processing; the prior-to-processing data preservation identifier is used for identifying whether to retain prior-to-processing image data; and the image data is used for identifying the prior-to-processing image data per se.

Understandably, the image processing information can further include other information, such as an identifier of the image processing information. If the image processing information includes the identifier of the image processing information, the length of the image processing information includes a length of the identifier of the image processing information. Specific settings are possible according to actual requirements. Here, the embodiment of the present application is only described by taking an example where the image processing information may include at least one of the foregoing, however, it does not mean that the embodiments of the present application are limited thereto. In an implementation, the identifier of the image processing information is used for identifying an “image processing information” field. In an implementation, the image processing information may be shown in Table 1 below:

TABLE 1

| Type | Item | Description |
|---|---|---|
| Image | Identifier of the | Identify an “image processing |
| processing | image processing | information” field |
| information | information | |
| | Length of the | Identify an overall length of the |
| | image processing | image processing information field |
| | information | |
| | Processing | Identify information on first-time |
| | identifier ID1 | image processing |
| | Processing- | Identify whether the first-time image |
| | reversible | processing is reversible processing |
| | identifier 1 | |
| | Processing | Identify type description of the first- |
| | description type | time image processing |
| | information 1 | |
| | Prior-to-processing | Identify whether to retain prior-to- |
| | data preservation | processing image data |
| | identifier 1 | |
| | Image data 1 | Identify the prior-to-processing |
| | | image data per se |
| | . . . | . . . |
| | Processing | Identify information on n^{-th}-time |
| | identifier IDn | image processing |
| | Processing- | Identify whether the n^{-th}-time image |
| | reversible | processing is reversible processing |
| | identifier n | |
| | Processing | Identify type description of the n^{-th}- |
| | description type | time image processing |
| | information n | |
| | Prior-to-processing | Identify whether to retain prior-to- |
| | data preservation | processing image data |
| | identifier n | |
| | Image data n | Identify the prior-to-processing |
| | | image data per se |

In an implementation, when processing the image data stream according to the image processing instruction, determining or generating the corresponding image processing information, and obtaining the target image, what is possible is to: determine or generate the corresponding image processing information firstly, and then obtain the target image; or, obtain the target image firstly, and then determine or generate the corresponding image processing information; or, determine or generate the corresponding image processing information and obtain the target image simultaneously. Specific settings are possible according to actual requirements. Here, the execution sequence between the two operations of determining or generating the corresponding image processing information and obtaining the target image is not specifically limited in the embodiments of the present application.

In an implementation, in the embodiments of the present application, the image data may be included in the image data stream, so that when the image data stream is processed according to the image processing instruction, the image data in the image data stream can be processed according to the image processing instruction, to obtain the target image data, and determine or generate the corresponding image processing information; to generate a final target image according to the target image data. In an implementation, in conjunction with the above-described capturing apparatus shown in FIG. 4, the image data in the image data stream can be image data for which a shooting picture is collected by the optical imaging hardware module in the capturing apparatus as needed. In addition, when collecting the image data of the shooting picture, the optical imaging hardware module will also determine or generate basic image information corresponding to the image data, and the relevant content of the basic image information will be described later.

In an implementation, when processing the image data according to the image processing instruction to obtain the target image data, and determining or generating the corresponding image processing information, what is possible is to: obtain target image data firstly, and then determine or generate the corresponding image processing information; or, determine or generate the corresponding image processing information, and then obtain target image data; or, obtain target image data and determine or generate the corresponding image processing information simultaneously. Specific settings are possible according to actual requirements. Here, the execution sequence between the two operations of obtaining the target image data and determining or generating the corresponding image processing information is not specifically limited in the embodiments of the present application.

As seen in the embodiment of the present application, it is possible to first acquire an image data stream when acquiring a target image; and process the image data stream according to an image processing instruction, determine or generate corresponding image processing information, and obtain the target image. In this way, the target image can be quickly acquired, thereby effectively improving the acquisition efficiency of the target image.

### Embodiment 2

Based on the foregoing embodiment shown in FIG. 3, in an embodiment of the present application, in an implementation, besides including image data, the image data stream may further include basic image information corresponding to the image data. In this way, the image data and the basic image information would be carried in the image data stream, so that both the image data and the basic image information corresponding thereto can be acquired through one image data stream, and thus there is no need to additionally acquire the basic image information in other manners, thereby improving the acquisition efficiency of the basic image information. In an implementation, as shown in FIG. 4, the basic image information may be basic image information corresponding to image data, determined or generated by the optical imaging hardware module in the capturing apparatus when collecting the image data of the shooting picture.

In an implementation, as shown in FIG. 4, when acquiring the target image of the shooting picture by the capturing apparatus, the basic image information corresponding to the image data may be generated when the optical imaging hardware module firstly collects the image data of the shooting picture; and the image data and the basic image information corresponding thereto may be carried in the same image data stream, and transmitted to the image processing module 1 of the at least one image processing module, so that the image processing module 1 can acquire both the image data and the basic image information corresponding thereto through the same image data stream. In this way, there is no need for the image processing module 1 to additionally acquire the basic image information in other manners, thereby improving the acquisition efficiency of the basic image information.

It should be illustrated that, in the embodiments of the present application, the encapsulation format in which the same image data stream carries the image data and the basic image information corresponding thereto is not limited to the optical imaging hardware module in the capturing apparatus, but also applicable to an image processing module in the capturing apparatus, that is, after the image processing module finishes processing the image data, the processed image data and the basic image information corresponding thereto also need to be carried in the same image data stream, for transmission to a next image processing module, so that the next image processing module acquires the processed image data and the corresponding basic image information based on the same image data stream. The difference lies in that: the image processing module 1 acquires the image data and the basic image information corresponding thereto from the optical imaging hardware module through the same image data stream, whereas the image processing module 2, the image processing module 3, . . . , and the image processing module N acquire the processed image data and the basic image information corresponding thereto from preceding image processing modules through the same image data stream.

In conjunction with the foregoing description, when the same image data stream carries both the image data and the basic image information corresponding thereto, the image data stream includes both the image data and the basic image information corresponding thereto. In an implementation, in an encapsulation format of the image data stream, the basic image information corresponding to the image data stream is located before the image data, in the image data stream. Certainly, the basic image information may also be located after the image data. Specific settings are possible according to actual requirements. Here, an embodiment of the present application is only described by using an example in which the basic image information, in the image data stream, is located before the image data, but it does not mean that the embodiments of the present application are merely limited thereto.

In an implementation, in the embodiment of the present application, the basic image information may include at least one of a length of the basic image information, a type identifier of the image data, a length of the image data, a width of the image data, a color space of the image data, a bit width of the image data, or a storage mode of the image data, which may be specifically set according to actual requirements.

In an implementation, the length of the basic image information is used for identifying an overall length of a basic image information field; the type identifier of the image data is used for identifying that the type of the image data is a single-frame image, a multi-frame image or a video stream; the length of the image data is used for identifying the length of the image data per se; the width of the image data is used for identifying the width of the image data per se; the color space of the image data is used for identifying a color space description of the image data, for example, a color space description of an RGGB (Red-Green-Green-Blue) mode, a color space description of an RGBW (Red-Green-Blue-White) mode, a color space description of an RYYB (Red-Yellow-Yellow-Blue) mode, etc.; the bit width of the image data is used for identifying a Bit number of each component of an image; and the storage mode of the image data is used for identifying, in the image color space, a mode in which each pixel of each component is arranged in the memory.

It can be understood that the basic image information can further include other information, such as an identifier of the basic image information. If the basic image information includes the identifier of the basic image information, the length of the basic image information includes a length of the identifier of the basic image information. Specific settings are possible according to actual requirements. Here, the embodiment of the present application is only described by taking an example where the basic image information may include at least one of the foregoing types, however, it does not mean that the embodiments of the present application are limited thereto. In an implementation, the identifier of the basic image information is used for identifying a “basic description information” field of the image. In an implementation, the basic image information may be shown in Table 2 below:

TABLE 2

| Type | Item | Description |
|---|---|---|
| Basic | Identifier of the | Identify a “basic description |
| image | basic image | information” field of an image |
| information | information | |
| | Length of the basic | Identify an overall length of the basic |
| | image information | image information field |
| | Type identifier of | Identify whether the type of the |
| | image data | image data is a single-frame image, |
| | | a multi-frame image or a video |
| | | stream |
| | Length of the | Identify the length of the image data |
| | image data | per se |
| | Width of the image | Identify the width of the image data |
| | data | per se |
| | Color space of the | Identify a color space description of |
| | image data | the image data |
| | Bit width of the | Identify a Bit number of each |
| | image data | component of the image |
| | Storage mode of | Identify, in the image color space, a |
| | the image data | mode in which each pixel of each |
| | | component is arranged in the memory |

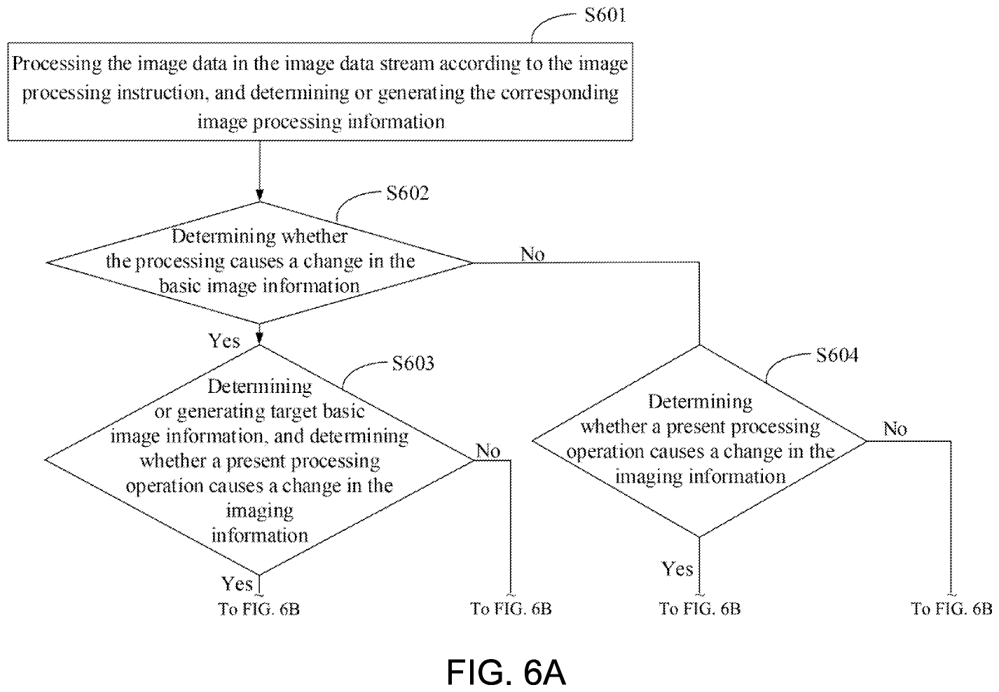

In conjunction with the foregoing description, when the image data stream includes the image data and the basic image information corresponding thereto, in order to facilitate the understanding that, in S2, how to process the image data stream according to the image processing instruction, determine or generate the corresponding image processing information, and obtain the target image, detailed description is made hereunder with the embodiment as shown in FIG. 5 below.

FIG. 5 is a flowchart of another image processing method according to an embodiment of the present application. The image processing method also can be executed by software and/or a hardware apparatus. In an implementation, reference is made to FIG. 5, the image processing method may include the following.

S501: processing the image data in the image data stream according to the image processing instruction, and determining or generating the corresponding image processing information.

It should be illustrated that, in S501, the related operation of processing the image data in the image data stream according to the image processing instruction, and determining or generating the corresponding image processing information is similar to the related operation in S2 as described above for processing the image data stream according to the image processing instruction, and determining or generating the corresponding image processing information. For details, reference may be made to the related description in S2 as described above for processing the image data stream according to the image processing instruction, and determining or generating the corresponding image processing information. Here, repetitive description will not be made in the embodiment of the present application.

In light of a common case where a change might be caused in the basic image information after the image data is processed according to the image processing instruction, hence it may be determined, after the image data is processed according to the image processing instruction, whether the present processing will cause a change in the basic image information, that is, S502 in the following description will be executed.

S502: determining whether the processing causes a change in the basic image information.

If it is determined that a change exists in the basic image information, it is proceeded with execution of S503 in the following description; and/or, if it is determined that no change exists in the basic image information, it is proceeded with execution of S504 in the following description.

S503: if it is determined that a change exists in the basic image information, determining or generating target basic image information, updating the image data stream based on the target basic image information, the target image data and the image processing information, to obtain a target image data stream, and obtaining the target image according to the target image data stream.

Understandably, when the basic image information is changed, it is necessary to determine or generate target basic image information after the change, and update the image data stream based on the target basic image information; in addition, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target basic image information, the target image data and the image processing information, in an implementation, the basic image information in the image data stream may be updated by using the target basic image information, and the image data in the image data stream may be updated by using the target image data, and the image processing information is add to the image data stream, to update the image data stream, so that the target image data stream after the updating is obtained.

In an implementation, when updating the basic image information in the image data stream by using the target basic image information, the basic image information may be replaced directly with the target basic image information, or only a part of the basic image information that is different from the target basic image information may be updated with the target basic image information, without updating the same part. Specific settings are possible according to actual requirements, which is not specifically limited in the embodiment of the present application herein. It can be understood that the updating method corresponding to the case when updating the image data by using the target image data is similar to the method for updating the basic image information, and reference may be made to the related description of the method for updating the basic image information, and details will not be described again in the embodiments of the present application herein.

After the image data stream is updated based on the target basic image information, the target image data and the image processing information, the obtained target image data stream may include the target basic image information, the target image data and the image processing information. When the target image data stream includes the target basic image information, the target image data and the image processing information, in an implementation, in an encapsulation format of the target image data stream, the image processing information, in the target image data stream, is located between the target basic image information and the target image data. Certainly, the image processing information may also be located after the target basic image information and the target image data, or in other encapsulation formats. Here, the embodiment of the present application is only described by taking such encapsulation format as an example, in which the image processing information is located between the target basic image information and the target image data, however, it does not mean that the embodiments of the present application are merely limited thereto.

In this scenario, after the image data is processed according to the image processing instruction, if it is determined that the present processing causes a change in the basic image information in the image data stream, the image data stream is updated based on the target basic image information, the target image data and the image processing information, to obtain a target image data stream. In this way, the target basic image information, the target image data and the image processing information would be carried together in the target image data stream, and thus there is no need to additionally acquire the target basic image information and the image processing information in other manners, so that the target image can be quickly acquired based on the target image data stream, thereby effectively improving the acquisition efficiency of the target image.

S504: if it is determined that no change exists in the basic image information, updating the image data stream based on the target image data and the image processing information, to obtain a target image data stream, and obtaining the target image according to the target image data stream.

Understandably, when the basic image information is not changed, there is no need to update the basic image information in the image data stream; however, since the image data will definitely be changed after the image data is processed according to the image processing instruction, it is necessary to determine or generate new target image data, and update the image data stream based on the target image data; furthermore, since the corresponding image processing information may be determined or generated in the present processing, it is also necessary to update the image data stream based on the image processing information.

When the target image data stream is obtained by updating the image data stream based on the target image data and the image processing information, in an implementation, the image data in the image data stream may be updated by using the target image data, and add the image processing information to the image data stream, to update the image data stream, so that the target image data stream after the updating can be obtained.

It can be understood that the updating method corresponding to the case when updating the image data by using the target image data is similar to the method for updating the basic image information as described above in S503, and reference may be made to the related description of the method for updating the basic image information, and details will not be described again in the embodiments of the present application herein.

After the image data stream is updated based on the target image data and the image processing information, the obtained target image data stream may include the basic image information, the target image data and the image processing information. When the target image data stream includes the basic image information, the target image data and the image processing information, in an implementation, in an encapsulation format of the target image data stream, the image processing information, in the target image data stream, is located between the basic image information and the target image data. Certainly, the image processing information may also be located after the basic image information and the target image data, or in other encapsulation formats. Here, the embodiment of the present application is only described by taking such encapsulation format as an example, in which the image processing information is located between the basic image information and the target image data, however, it does not mean that the embodiments of the present application are merely limited thereto.

In this scenario, after the image data is processed according to the image processing instruction, if it is determined that the present processing causes no change in the basic image information in the image data stream, the image data stream is updated based on the basic image information, the target image data and the image processing information, to obtain a target image data stream. In this way, the basic image information, the target image data and the image processing information would be carried together in the target image data stream, and thus there is no need to additionally acquire the basic image information and the image processing information in other manners, so that the target image can be quickly acquired based on the target image data stream, thereby effectively improving the acquisition efficiency of the target image.

### Embodiment 3

Based on the foregoing embodiment shown in FIG. 5, in an embodiment of the present application, in an implementation, the image data stream, in addition to including the image data and the basic image information corresponding thereto, may further include imaging information. In this way, the image data, the basic image information and the imaging information is carried in the image data stream, so that the image data, the basic image information and the imaging information can be acquired together by one image data stream, and thus there is no need to additionally acquire the basic image information and the imaging information in other manners, thereby effectively improving the acquisition efficiency of the basic image information and the imaging information.

In conjunction with the foregoing description, when the same image data stream carries the image data, the basic image information and the imaging information simultaneously, in an implementation, in an encapsulation format of the image data stream, both the imaging information and the image processing information, in the image data stream, are located between the basic image information and the image data, and the imaging information is located before the image processing information. Certainly, there may also be other encapsulation formats, and specific settings are possible according to actual requirements. Here, the embodiment of the present application is only described by using such encapsulation format as an example, however, it does not mean that the embodiments of the present application are merely limited thereto.

In an implementation, in the embodiment of the present application, the imaging information may include at least one of a length of the imaging information, a shutter time of an imaging device, a photo-sensibility of the imaging device, an aperture of the imaging device, a focal length of the imaging device, gyroscope information of the imaging device, an acceleration of the imaging device, geographical location information of the imaging device or image rotation angle information of the imaging device, and specific settings are possible according to actual requirements.

In an implementation, the length of the imaging information is used for identifying an overall length of an imaging information field; the shutter time of the imaging device is used for identifying the time when the light enters a photosensitive surface of photosensitive material during photographing, that is, a camera shutter speed; the photo-sensibility of the imaging device is used for identifying a value of photo-sensibility during image capturing, which can be defined with reference to ISO 12232; the aperture of the imaging device is used for identifying an aperture value of a lens, and the numerical value is a focal length of the lens/an effective aperture diameter of the lens; the focal length of the imaging device is used for identifying a physical focal length of the lens, that is, a distance from a lens focal point to a lens central point; the gyroscope information of the imaging device is used for identifying an angular speed of an intelligent terminal device, including X, Y and Z axis directions; the acceleration of the imaging device is used for identifying a magnitude of acceleration of three axes of the intelligent terminal device; the geographic location information of the imaging device is used for identifying longitude, latitude and elevation; and the image rotation angle information of the imaging device is used for identifying information of a rotation angle of an image on the intelligent terminal.

It can be understood that the imaging information can further include other information, for example, an identifier of the imaging information. If the imaging information includes the identifier of the imaging information, then the length of the imaging information includes a length of the identifier of the imaging information, and specific settings are possible according to actual requirements. Here, the embodiment of the present application is only described by taking an example where the imaging information may include at least one of the foregoing, however, it does not mean that the embodiments of the present application are merely limited thereto. In an implementation, the identifier of the imaging information is used for identifying an “imaging information” field. In an implementation, the imaging information may be shown in Table 3 below:

TABLE 3

| Type | Item | Description |
|---|---|---|
| Imaging | Identifier of the | Identify an “imaging information” |
| information | imaging Information | field |
| | Length of the | Identify an overall length of the |
| | imaging information | imaging information field |
| | Shutter time of an | Identify the time when the light |
| | imaging device | enters a photosensitive surface of |
| | | photosensitive material during |
| | | photographing |
| | Photo-sensibility of | Identify a value of photo- |
| | the imaging device | sensibility during image capturing |
| | Aperture of the | Identify an aperture value of a lens |
| | imaging device | |
| | Focal length of the | Identify a physical focal length of |
| | imaging device | the lens |
| | Gyroscope | Identify an angular velocity of an |
| | information of the | intelligent terminal device |
| | imaging device | |
| | Acceleration of the | Identify a magnitude of |
| | imaging device | acceleration of three axes of the |
| | | intelligent terminal device |
| | Geographical | Identify longitude, latitude, and |
| | location information | elevation |
| | of the imaging device | |
| | Image rotation | Identify information of a rotation |
| | angle information of | angle of an image on the intelligent |
| | the imaging device | terminal |

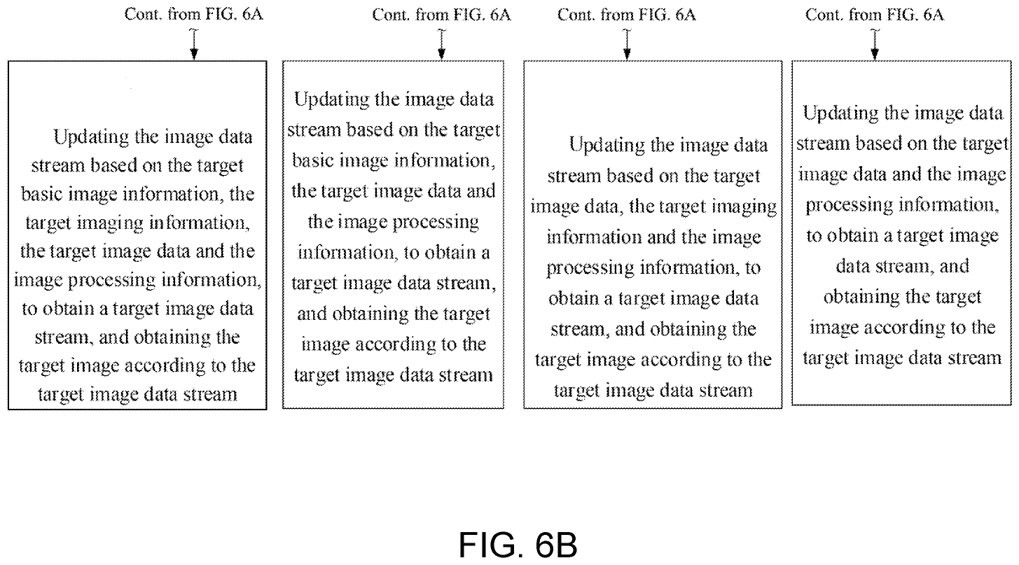

In conjunction with the foregoing description, when the image data stream includes the image data, the basic image information and the imaging information corresponding thereto, in order to facilitate the understanding that, in S2, how to process the image data stream according to the image processing instruction, determine or generate the corresponding image processing information, and obtain the target image, detailed description is made hereunder with the embodiment as shown in FIGS. 6A-6B below.

FIGS. 6A-6B are flowcharts of yet another image processing method according to an embodiment of the present application. The image processing method also can be executed by software and/or a hardware apparatus. In an implementation, reference is made to FIGS. 6A-6B, the image processing method may include the following.

S601: processing the image data in the image data stream according to the image processing instruction, and determining or generating the corresponding image processing information.

It should be illustrated that, in S601, the related operation of processing the image data in the image data stream according to the image processing instruction, and determining or generating the corresponding image processing information is similar to the related operation in S2 as described above for processing the image data stream according to the image processing instruction, and determining or generating the corresponding image processing information. For details, reference may be made to the related description in S2 as described above for processing the image data stream according to the image processing instruction, and determining or generating the corresponding image processing information. Here, repetitive description will not be made in the embodiment of the present application.

In light of a common case where a change might be caused in the basic image information and the imaging information after the image data is processed according to the image processing instruction, hence it may be determined, after the image data is processed according to the image processing instruction, whether the present processing will cause a change in the basic image information and the imaging information, to determine whether to update the image data stream.

In an implementation, when determining whether the present processing will cause a change in the basic image information and the imaging information, it is possible to first determine whether the present processing will cause a change in the basic image information, and then determine whether the present processing will cause a change in the imaging information; or, first determine whether the present processing will cause a change in the imaging information, and then determine whether the present processing will cause a change in the basic image information; or, determine whether the present processing will cause a change in both the basic image information and the imaging information. Specific settings are possible according to actual requirements.

Description is made in the embodiment of the present application by taking an example of determining whether the present processing will cause a change in the basic image information, followed by determining whether the present processing will cause a change in the imaging information. After the image data is processed according to the image processing instruction, it can be first determined that whether the present processing will cause a change in the basic image information, that is, S602 below is executed.

S602: determining whether the processing causes a change in the basic image information.

If it is determined that a change exists in the basic image information, it is proceeded with execution of S603 in the following description; and/or, if it is determined that no change exists in the basic image information, it is proceeded with execution of S604 in the following description.

S603: if it is determined that a change exists in the basic image information, determining or generating target basic image information, and determining whether a present processing operation causes a change in the imaging information, and updating the image data stream based on a determination result, to obtain a target image data stream, and obtaining the target image according to the target image data stream.

When determining whether the present processing operation causes a change in the imaging information, the following two situations may be included, respectively: a change exists in the imaging information and no change exists in the imaging information.

In one situation, when it is determined that the imaging information is changed, it is necessary to determine target imaging information after the updating. Since both the basic image information and the imaging information is changed, it is necessary to update the image data stream based on the target basic image information and the target imaging information after the change; in addition, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target basic image information, the target imaging information, the target image data and the image processing information, In an implementation, the basic image information in the image data stream is updated by using the target basic image information, the imaging information in the image data stream is updated by using the target imaging information, the image data in the image data stream is updated by using the target image data, and the image processing information is added to the image data stream, to update the image data stream, so that the target image data stream after the updating is obtained.

In an implementation, when updating the imaging information in the image data stream by using the target imaging information, the imaging information may be replaced directly with the target imaging information, or only a part of the imaging information that is different from the target imaging information may be updated with the target imaging information, without updating the same part. Specific settings are possible according to actual requirements, which is not limited in the embodiment of the present application herein. As for how to update the basic image information in the image data stream by using the target basic image information and how to update the image data in the image data stream by using the target image data, reference may be made to the related description of the embodiment as shown in FIG. 5, and details will not be described again in the embodiments of the present application herein.

After the image data stream is updated based on the target basic image information, the target imaging information, the target image data and the image processing information, the obtained target image data stream may include the target basic image information, the target imaging information, the target image data and the image processing information. When the target image data stream includes the target basic image information, the target imaging information, the target image data and the image processing information, In an implementation, in an encapsulation format of the target image data stream, both the target imaging information and the image processing information, in the target image data stream, are located between the target basic image information and the target image data, and the target imaging information is located before the image processing information, that is, sequentially: the target basic image information, the target imaging information, the image processing information, and the target image data. Certainly, there may also be other encapsulation formats, and specific settings are possible according to actual requirements. Here, the embodiment of the present application is only explained by taking such encapsulation format as an example, however, it does not mean that the embodiments of the present application are merely limited thereto.

In this case, after the image data is processed according to the image processing instruction, if it is determined that the present processing causes a change in both the basic image information and the imaging information in the image data stream, the image data stream is updated based on the target basic image information, the target imaging information, the target image data and the image processing information, to obtain a target image data stream. In this way, the target basic image information, the target imaging information, the target image data and the image processing information would be carried together in the target image data stream, and thus there is no need to additionally acquire the target basic image information, the target imaging information and the image processing information in other manners, so that the target image can be quickly acquired based on the target image data stream, thereby effectively improving the acquisition efficiency of the target image.

In the other situation, when it is determined that the imaging information is not changed, there is no need to update the imaging information in the image data stream. However, since the basic image information is changed, it is necessary to update the image data stream based on the target basic image information after the change; in addition, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target basic image information, the target image data and the image processing information, In an implementation, the basic image information in the image data stream can be updated by using the target basic image information, the image data in the image data stream can be updated by using the target image data, and the image processing information is added to the image data stream, to update the image data stream, so that the target image data stream after the updating is obtained.

It should be illustrated that in S603, as for how to update the basic image information in the image data stream by using the target basic image information and how to update the image data in the image data stream by using the target image data, reference may be made to the related description of the embodiment as shown in FIG. 5, and details will not be described again in the embodiments of the present application herein.

After the image data stream is updated based on the target basic image information, the target image data and the image processing information, the obtained target image data stream may include the target basic image information, the imaging information, the target image data and the image processing information. When the target image data stream includes the target basic image information, the imaging information, the target image data and the image processing information, In an implementation, in an encapsulation format of the target image data stream, both the imaging information and the image processing information, in the target image data stream, are located between the target basic image information and the target image data, and the imaging information is located before the image processing information. Certainly, there may also be other encapsulation formats, and specific settings are possible according to actual requirements. Here, the embodiment of the present application is only explained by taking such encapsulation format as an example, however, it does not mean that the embodiments of the present application are merely limited thereto.

In this case, after the image data is processed according to the image processing instruction, if it is determined that the present processing causes a change in the basic image information in the image data stream and no change in the imaging information, the image data stream is updated based on the target basic image information, the target image data and the image processing information, to obtain a target image data stream. In this way, the target basic image information, the imaging information, the target image data and the image processing information would be carried together in the target image data stream, and thus there is no need to additionally acquire the target basic image information, the imaging information and the image processing information in other manners, so that the target image can be quickly acquired based on the target image data stream, thereby effectively improving the acquisition efficiency of the target image.

S604: if it is determined that no change exists in the basic image information, determining whether a present processing operation causes a change in the imaging information, and updating the image data stream based on a determination result, to obtain a target image data stream, and obtaining the target image according to the target image data stream.

When determining whether the present processing operation causes a change in the imaging information, the following two situations may be included, respectively: a change exists in the imaging information and no change exists in the imaging information.

In one situation, when it is determined that the imaging information is changed, it is necessary to determine target imaging information after the updating, and thus it is necessary to update the image data stream based on the target imaging information after the change; however, since the basic image information is not changed, there is no need to update the image data stream based on the basic image information. In addition, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target image data, the target imaging information and the image processing information, in an implementation, the image data in the image data stream can be updated by using the target image data, the imaging information in the image data stream can be updated by using the target imaging information, and the image processing information is added to the image data stream, to update the image data stream, so that the target image data stream after the updating is obtained.

It should be illustrated that, in S604, as for how to update the image data in the image data stream by using the target image data and how to update the imaging information in the image data stream by using the target imaging information, reference may be made to the related description as described above in S603, and details will not be described again in the embodiments of the present application herein.

After the image data stream is updated based on the target image data, the target imaging information and the image processing information, the obtained target image data stream may include the basic image information, the target imaging information, the target image data and the image processing information. When the target image data stream includes the basic image information, the target imaging information, the target image data and the image processing information, In an implementation, in an encapsulation format of the target image data stream, both the target imaging information and the image processing information, in the target image data stream, are located between the basic image information and the target image data, and the target imaging information is located before the image processing information. Certainly, there may also be other encapsulation formats, and specific settings are possible according to actual requirements. Here, the embodiment of the present application is only explained by taking such encapsulation format as an example, however, it does not mean that the embodiments of the present application are merely limited thereto.

In this case, after the image data is processed according to the image processing instruction, if it is determined that the present processing causes no change in the basic image information in the image data stream and a change in the imaging information, the image data stream is updated based on the target image data, the target imaging information and the image processing information, to obtain a target image data stream. In this way, the basic image information, the target imaging information, the target image data and the image processing information would be carried together in the target image data stream, and thus there is no need to additionally acquire the basic image information, the target imaging information and the image processing information in other manners, so that the target image can be quickly acquired based on the target image data stream, thereby effectively improving the acquisition efficiency of the target image.

In the other situation, when it is determined that the imaging information is not changed, since neither the basic image information nor the imaging information is changed, there is no need to update the image data stream based on the basic image information and the imaging information; however, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target image data and the image processing information, in an implementation, the image data in the image data stream can be updated by using the target image data, and the image processing information is added to the image data stream, to update the image data stream, so that the target image data stream after the updating is obtained.

It should be illustrated that, as for how to update the image data in the image data stream by using the target image data, reference may be made to the related description of the embodiment as shown in FIG. 5, and details will not be described again in the embodiments of the present application herein.

After the image data stream is updated based on the target image data and the image processing information, the obtained target image data stream may include the basic image information, the imaging information, the target image data and the image processing information. When the target image data stream includes the basic image information, the imaging information, the target image data and the image processing information, in an implementation, in an encapsulation format of the target image data stream, both the imaging information and the image processing information, in the target image data stream, are located between the basic image information and the target image data, and the imaging information is located before the image processing information, that is, sequentially: the basic image information, the imaging information, the image processing information, and the target image data. Certainly, there may also be other encapsulation formats, and specific settings are possible according to actual requirements. Here, the embodiment of the present application is only explained by taking such encapsulation format as an example, however, it does not mean that the embodiments of the present application are merely limited thereto.

In this case, after the image data is processed according to the image processing instruction, if it is determined that the present processing causes no change to either the basic image information or the imaging information in the image data stream, the image data stream is updated based on the target image data and the image processing information, to obtain a target image data stream. In this way, the basic image information, the imaging information, the target image data and the image processing information would be carried together in the target image data stream, and thus there is no need to additionally acquire the basic image information, the imaging information and the image processing information in other manners, so that the target image can be quickly acquired based on the target image data stream, thereby effectively improving the acquisition efficiency of the target image.

### Embodiment 4

Based on any of the foregoing embodiments, in an implementation, in the embodiment of the present application, the image data stream may further include original image processing information corresponding to the image data. In this way, the image data and the original image processing information would be carried in the image data stream, so that the image data and the original image processing information can be acquired together through one image data stream, and thus there is no need to additionally acquire the original image processing information in other manners, thereby improving the acquisition efficiency of the original image processing information. In an implementation, the original image processing information can be interpreted as information relevant to the image data being performed by image processing before.

In conjunction with the foregoing description, when the same image data stream carries both the image data and the original image processing information corresponding thereto, in an implementation, in an encapsulation format of the image data stream, the original image processing information, in the image data stream, is located before the image data. Certainly, the original image processing information may also be located after the image data, and specific settings are possible according to actual requirements. Here, the embodiment of the present application is only explained by taking such encapsulation format as an example, in which the original image processing information, in the image data stream, is located before the image data, however, it does not mean that the embodiments of the present application are merely limited thereto.

When the image data stream includes the original image processing information, after the image data stream is processed according to the image processing instruction and image processing information corresponding to a present processing operation is determined or generated, it is possible to add the image processing information corresponding to the present processing operation to the original image processing information in the image data stream, to update the image data stream, so that a target image data stream after the updating is obtained. In this way, the target image data stream will always include most-recent image processing information, so that an operation relevant to the present processing can be known according to the image processing information subsequently, proving a query basis for subsequent image data processing.

In an implementation, the original image processing information may further include a processing-reversible identifier. When the processing-reversible identifier indicates reversible processing, it represents that the image data prior to processing can be recovered based on the updated target image data and the original image processing information in subsequent; in this case, in order to avoid large memory occupation due to storage of the image data, the image data can be eliminated from the updated target image data stream after adding the target image data to the image data stream, so that the large memory occupation due to the storage of the image data can be avoided, thereby reducing the memory occupation. And/or, when the processing-reversible identifier indicates that the present processing is irreversible processing, it represents that the image data prior to processing cannot be recovered based on the updated target image data and the original image processing information in subsequent, then the image data prior to processing needs to be carried in the updated target image data stream, to ensure that the image data can be accurately found in subsequent.

### Embodiment 5

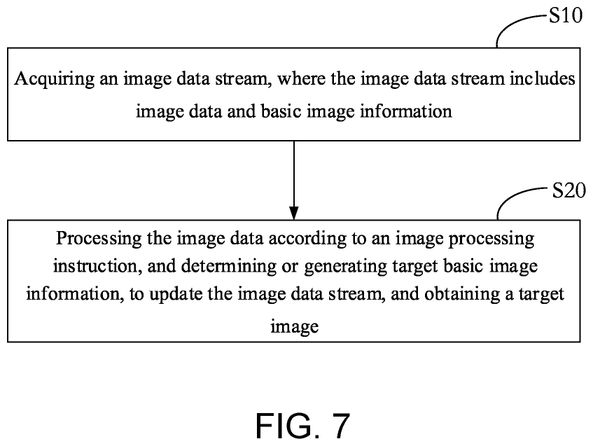

FIG. 7 is a flowchart of an image processing method according to an embodiment of the present application. The image processing method also can be executed by software and/or a hardware apparatus. For example, the hardware apparatus may be an image processing apparatus which may be an intelligent terminal. In an implementation, reference is made to FIG. 7, the image processing method may include the following.

S10: acquiring an image data stream, where the image data stream includes image data and basic image information.

In an implementation, in the embodiment of the present application, the basic image information may include at least one of a length of the basic image information, a type identifier of the image data, a length of the image data, a width of the image data, a color space of the image data, a bit width of the image data, or a storage mode of the image data, which may be specifically set according to actual requirements. The relevant description thereof can be found in the relevant description of the basic image information in Embodiment 2 shown in FIG. 3, which will not be described again in the embodiment of the present application herein.

In an implementation, when acquiring the image data stream: an image data stream transmitted by an optical imaging hardware module of a capturing apparatus can be received; or an image data stream transmitted by another image processing module of the capturing apparatus may also be received. Specific settings are possible according to actual requirements. Here, a manner for acquiring the image data stream is not specifically limited in the embodiments of the present application. In an implementation, as shown in FIG. 4, when acquiring the target image of the shooting picture by the capturing apparatus, the basic image information corresponding to the image data may be generated when the optical imaging hardware module firstly collects the image data of the shooting picture; and the image data and the basic image information corresponding thereto may be carried in the same image data stream.

In conjunction with the foregoing description, when the same image data stream carries both the image data and the basic image information corresponding thereto, the image data stream includes both the image data and the basic image information corresponding thereto. In an implementation, in an encapsulation format of the image data stream, the basic image information corresponding to the image data stream, in the image data stream, is located before the image data. Certainly, the basic image information may also be located after the image data. Specific settings are possible according to actual requirements. Here, the embodiment of the present application is only described by using an example in which the basic image information, in the image data stream, is located before the image data, but it does not mean that the embodiments of the present application are merely limited thereto.

After the image data is acquired, the image data is processed according to an image processing instruction. In addition, since a change is usually caused in the basic image information after the image data is processed according to the image processing instruction, hence after the image data is processed according to the image processing instruction, it is possible to determine or generate target basic image information after the change, to update the image data stream, and obtain a target image, that is, S20 in the following description is executed.

S20: processing the image data according to an image processing instruction, and determining or generating target basic image information, to update the image data stream, and obtaining a target image.

In an implementation, the image processing instruction may be an image processing instruction generated based on an image processing requirement, or may be a preset image processing instruction. Specific settings are possible according to actual requirements, which here are not specifically limited in the embodiments of the present application.

In an implementation, the processing the image data stream according to the image processing instruction may include, but is not limited to, RAW domain noise reduction processing, low-light enhancement processing, HDR composition processing and the like, which may be specifically set according to actual requirements. The relevant description thereof can be found in the relevant description of the image processing instruction as described above in S2, which will not be described again in the embodiment of the present application herein.

In an implementation, when processing the image data according to the image processing instruction, it is possible to first process the image data according to the image processing instruction to obtain target image data, and determine or generate corresponding target image processing information; then update the image data stream based on the target basic image information, the target image data and the image processing information, to obtain a target image data stream, and obtain the target image according to the target image data stream.

In an implementation, when processing the image data according to the image processing instruction to obtain target image data, and determining or generating the corresponding target image processing information, what is possible is to: obtain the target image data firstly, and then determine or generate the corresponding target image processing information; or, determine or generate the corresponding target image processing information firstly, and then obtain the target image data; or, obtain the target image data and determine or generate the corresponding target image processing information simultaneously. Specific settings are possible according to actual requirements. Here, the execution sequence between the two operations of obtaining the target image data and determining or generating the corresponding target image processing information is not specifically limited in the embodiments of the present application.

In an implementation, when updating the image data stream based on the target basic image information, the target image data and the image processing information, the basic image information in the image data stream can be updated by using the target basic image information, and the image data in the image data stream can be updated by using the target image data, and the image processing information is added to the image data stream, to update the image data stream, so that the target image data stream after the updating is obtained.

In an implementation, when updating the basic image information in the image data stream by using the target basic image information, the basic image information may be replaced directly with the target basic image information, or only a part of the basic image information that is different from the target basic image information may be updated with the target basic image information, without updating the same part. Specific settings are possible according to actual requirements, which is not limited in the embodiment of the present application herein. It can be understood that the updating method corresponding to the case when updating the image data by using the target image data is similar to the method for updating the basic image information, and reference may be made to the related description of the method for updating the basic image information, and details will not be described again in the embodiments of the present application herein.

After the image data stream is updated based on the target basic image information, the target image data and the image processing information, the obtained target image data stream may include the target basic image information, the target image data and the image processing information. When the target image data stream includes the target basic image information, the target image data and the image processing information, In an implementation, in an encapsulation format of the target image data stream, the image processing information, in the target image data stream, is located between the target basic image information and the target image data. Certainly, the image processing information may also be located after the target basic image information and the target image data, or in other encapsulation formats. Here, the embodiment of the present application is only described by taking such encapsulation format as an example, in which the image processing information is located between the target basic image information and the target image data, however, it does not mean that the embodiments of the present application are merely limited thereto.

In this scenario, after the image data is processed according to the image processing instruction, if it is determined that the present processing causes a change in the basic image information in the image data stream, the image data stream is updated based on the target basic image information, the target image data and the image processing information, to obtain a target image data stream. In this way, the target basic image information, the target image data and the image processing information would be carried together in the target image data stream, and thus there is no need to additionally acquire the target basic image information and the image processing information in other manners, so that the target image can be quickly acquired based on the target image data stream, thereby effectively improving the acquisition efficiency of the target image.

As seen in the embodiment of the present application, it is possible to first acquire the image data stream when acquiring the target image, where the image data stream includes the image data and the basic image information; and process the image data stream according to the image processing instruction, determine or generate the target basic image information, to update the image data stream, and obtain the target image. In this way, the image data and the basic image information would be carried together in the image data stream, and the image data stream would be updated with the target basic image information, thus there is no need to additionally acquire the target basic image information in other manners, so that the target image can be quickly acquired based on the updated image data stream, thereby effectively improving the acquisition efficiency of the target image.

### Embodiment 6

Based on the foregoing embodiment shown in FIG. 7, in an embodiment of the present application, the image data stream, in addition to including the image data and the basic image information corresponding thereto, may further include imaging information. In this way, the image data, the basic image information and the imaging information would be carried in the image data stream, so that the image data, the basic image information and the imaging information can be acquired together by one image data stream, and thus there is no need to additionally acquire the basic image information and the imaging information in other manners, thereby effectively improving the acquisition efficiency of the basic image information and the imaging information.

In conjunction with the foregoing description, in an implementation, when the same image data stream carries the image data, the basic image information and the imaging information simultaneously, in an encapsulation format of the image data stream, both the imaging information and the image processing information, in the image data stream, are located between the basic image information and the image data, and the imaging information is located before the image processing information. Certainly, there may also be other encapsulation formats, and specific settings are possible according to actual requirements. Here, the embodiment of the present application is only described by using such encapsulation format as an example, however, it does not mean that the embodiments of the present application are merely limited thereto.

In an implementation, in the embodiment of the present application, the imaging information may include at least one of a length of the imaging information, a shutter time of an imaging device, a photo-sensibility of the imaging device, an aperture of the imaging device, a focal length of the imaging device, gyroscope information of the imaging device, an acceleration of the imaging device, geographical location information of the imaging device or image rotation angle information of the imaging device, and specific settings are possible according to actual requirements. The relevant description thereof can be found in the relevant description of the imaging information as described above in Embodiment 3, which will not be described again in the embodiment of the present application herein.

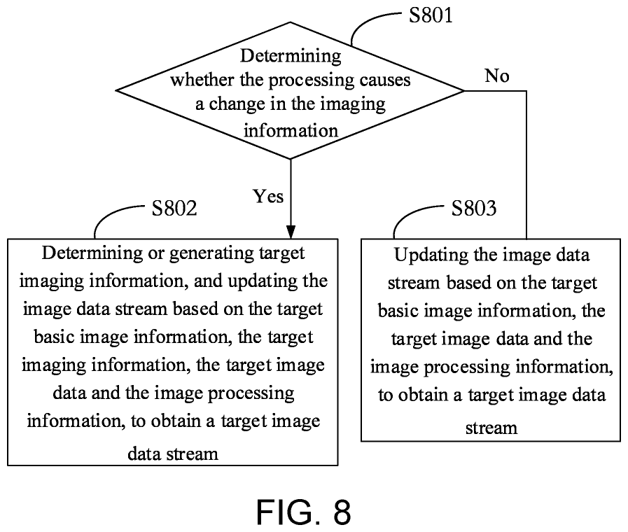

In conjunction with the foregoing description, when the image data stream includes the image data, the basic image information and the imaging information corresponding thereto, in order to facilitate the understanding that, in S20, how to update the image data stream based on the target basic image information, the target image data and the image processing information, detailed description is made hereunder with the embodiment as shown in FIG. 8 below.

FIG. 8 is a flowchart of another image processing method according to an embodiment of the present application. The image processing method also can be executed by software and/or a hardware apparatus. In an implementation, reference is made to FIG. 7, the image processing method may include the following.

S801: determining whether the processing causes a change in the imaging information.

In light of a common case where a change might be caused in the imaging information after the image data is processed according to the image processing instruction, hence it may be determined, after the image data is processed according to the image processing instruction, whether the present processing will cause a change in the imaging information, to determine whether to update the image data stream. If it is determined that a change exists in the imaging information, it is proceeded with execution of S802 in the following description; and/or, if it is determined that no change exists in the imaging information, it is proceeded with execution of S803 in the following description.

S802: if it is determined that a change exists in the imaging information, determining or generating target imaging information, and updating the image data stream based on the target basic image information, the target imaging information, the target image data and the image processing information, to obtain a target image data stream.

When it is determined that the imaging information is changed, it is necessary to determine target imaging information after the updating. Since both the basic image information and the imaging information are changed, it is necessary to update the image data stream based on the target basic image information and the target imaging information after the change; in addition, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target basic image information, the target imaging information, the target image data and the image processing information, in an implementation, the basic image information in the image data stream can be updated by using the target basic image information, the imaging information in the image data stream can be updated by using the target imaging information, the image data in the image data stream can be updated by using the target image data, and the image processing information is added to the image data stream, to update the image data stream, so that the target image data stream after the updating is obtained.

In an implementation, when updating the imaging information in the image data stream by using the target imaging information, the imaging information may be replaced directly with the target imaging information, or only a part of the imaging information that is different from the target imaging information may be updated with the target imaging information, without updating the same part. Specific settings are possible according to actual requirements, which is not specifically limited in the embodiment of the present application herein. As for how to update the basic image information in the image data stream by using the target basic image information and how to update the image data in the image data stream by using the target image data, reference may be made to the related description of the embodiment as shown in FIG. 5, and details will not be described again in the embodiments of the present application herein.

After the image data stream is updated based on the target basic image information, the target imaging information, the target image data and the image processing information, the obtained target image data stream may include the target basic image information, the target imaging information, the target image data and the image processing information. When the target image data stream includes the target basic image information, the target imaging information, the target image data and the image processing information, in an implementation, in an encapsulation format of the target image data stream, both the target imaging information and the image processing information, in the target image data stream, are located between the target basic image information and the target image data, and the target imaging information is located before the image processing information, that is, sequentially: the target basic image information, the target imaging information, the image processing information, and the target image data. Certainly, there may also be other encapsulation formats, and specific settings are possible according to actual requirements. Here, the embodiment of the present application is only explained by taking such encapsulation format as an example, however, it does not mean that the embodiments of the present application are merely limited thereto.

In this case, after the image data is processed according to the image processing instruction, if it is determined that the present processing causes a change in both the basic image information and the imaging information in the image data stream, the image data stream is updated based on the target basic image information, the target imaging information, the target image data and the image processing information, to obtain a target image data stream. In this way, the target basic image information, the target imaging information, the target image data and the image processing information would be carried together in the target image data stream, and thus there is no need to additionally acquire the target basic image information, the target imaging information and the image processing information in other manners, so that the target image can be quickly acquired based on the target image data stream, thereby effectively improving the acquisition efficiency of the target image.

S803: if it is determined that no change exists in the imaging information, updating the image data stream based on the target basic image information, the target image data and the image processing information, to obtain a target image data stream.

When it is determined that the imaging information is not changed, there is no need to update the imaging information in the image data stream. However, since the basic image information is changed, it is necessary to update the image data stream based on the target basic image information after the change; in addition, since the image data will definitely be changed after the image data is processed according to the image processing instruction, it is also necessary to determine or generate target image data after the change, and update the image data stream based on the target image data; furthermore, since the corresponding image processing information may be determined or generated in the present processing, it is also necessary to update the image data stream based on the image processing information.

When updating the image data stream based on the target basic image information, the target image data and the image processing information, in an implementation, the basic image information in the image data stream can be updated by using the target basic image information, the image data in the image data stream can be updated by using the target image data, and the image processing information is added to the image data stream, to update the image data stream, so that the target image data stream after the updating is obtained.

It should be illustrated that, in S803, as for how to update the basic image information in the image data stream by using the target basic image information and how to update the image data in the image data stream by using the target image data, reference may be made to the related description of the embodiment as shown in FIG. 5, and details will not be described again in the embodiments of the present application herein.

After the image data stream is updated based on the target basic image information, the target image data and the image processing information, the obtained target image data stream may include the target basic image information, the imaging information, the target image data and the image processing information. When the target image data stream includes the target basic image information, the imaging information, the target image data and the image processing information, in an implementation, in an encapsulation format of the target image data stream, both the imaging information and the image processing information, in the target image data stream, are located between the target basic image information and the target image data, and the imaging information is located before the image processing information, that is, sequentially: the target basic image information, the imaging information, the image processing information, and the target image data. Certainly, there may also be other encapsulation formats, and specific settings are possible according to actual requirements. Here, the embodiment of the present application is only explained by taking such encapsulation format as an example, however, it does not mean that the embodiments of the present application are merely limited thereto.

In this case, after the image data is processed according to the image processing instruction, if it is determined that the present processing causes a change in the basic image information in the image data stream and no change in the imaging information, the image data stream is updated based on the target basic image information, the target image data and the image processing information, to obtain a target image data stream. In this way, the target basic image information, the imaging information, the target image data and the image processing information would be carried together in the target image data stream, and thus there is no need to additionally acquire the target basic image information, the imaging information and the image processing information in other manners, so that the target image can be quickly acquired based on the target image data stream, thereby effectively improving the acquisition efficiency of the target image.

### Embodiment 7

Based on the foregoing embodiments as shown in FIG. 7 or FIG. 8, in an embodiment of the present application, the image data stream, besides including the image data and the corresponding basic imaging information, may further include original image processing information corresponding to the image data. In this way, the image data, the basic image information and the original image processing information would be carried in the image data stream, so that the image data, the basic image information and the original image processing information can be acquired together through one image data stream, and thus there is no need to additionally acquire the basic image information and the original image processing information in other manners, thereby improving the acquisition efficiency of the basic image information and the original image processing information. In an implementation, the original image processing information can be interpreted as information relevant to the image data being performed by image processing before.

In conjunction with the foregoing description, when the same image data stream carries the image data, the basic image information and the original image processing information simultaneously, in an implementation, in an encapsulation format of the image data stream, the original image processing information, in the image data stream, is located between the basic image information and the image data. Certainly, the original image processing information may also be located after the basic image information and the image data, or in other encapsulation formats. Here, the embodiment of the present application is only described by taking such encapsulation format as an example, in which the original image processing information is located before the basic image information and the image data, however, it does not mean that the embodiments of the present application are merely limited thereto.

When the image data stream includes the original image processing information, after the image data is processed according to the image processing instruction and image processing information corresponding to a present processing operation is determined or generated, it is possible to add the image processing information corresponding to the present processing operation to the original image processing information in the image data stream, to update the image data stream, so that a target image data stream after the updating is obtained. In this way, the target image data stream will always include most-recent image processing information, so that an operation relevant to the present processing can be known according to the image processing information subsequently, proving a query basis for subsequent image data processing.

In an implementation, the original image processing information may further include a processing-reversible identifier. When the processing-reversible identifier indicates reversible processing, it represents that the image data prior to processing can be recovered based on the updated target image data and the original image processing information in subsequent; in this case, in order to avoid large memory occupation due to storage of the image data, the image data can be eliminated from the updated target image data stream after adding the target image data to the image data stream, so that the large memory occupation due to the storage of the image data can be avoided, thereby reducing the memory occupation. And/or, when the processing-reversible identifier indicates that the present processing is irreversible processing, it represents that the image data prior to processing cannot be recovered based on the updated target image data and the original image processing information in subsequent, then the image data prior to processing needs to be carried in the updated target image data stream, to ensure that the image data can be accurately found in subsequent.

### Embodiment 8

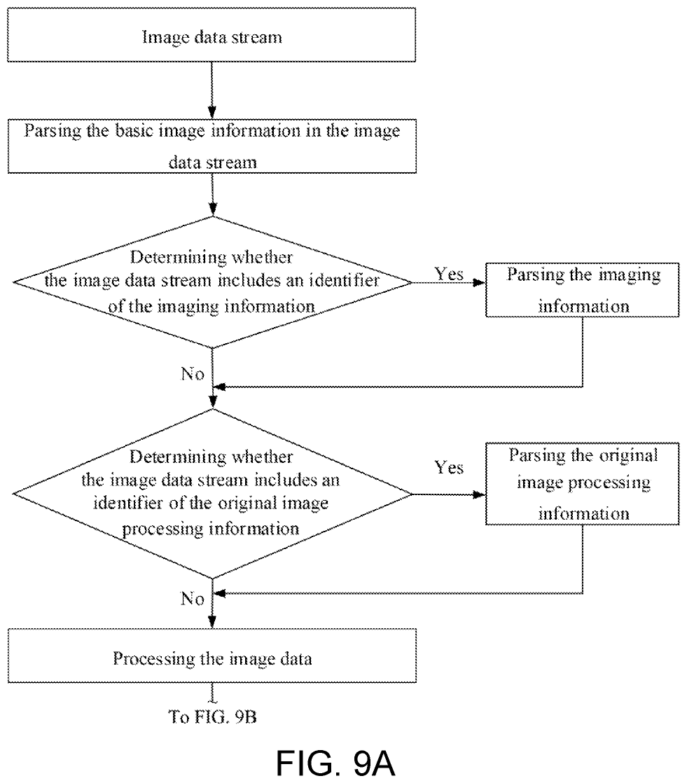

Based on any of the foregoing embodiments, in an actual computational photography scenario, assuming that the image data stream includes the image data and the basic image information, but it is not sure whether the imaging information and the original image processing information are included, then In an implementation, when processing the image data, reference may be made to FIGS. 9A-9B. FIGS. 9A-9B are flowcharts of yet another image processing method according to an embodiment of the present application. After the image data stream is acquired, the basic image information in the image data stream can be parsed firstly, and after the basic image information is obtained by parsing, then it is determined whether the image data stream includes an identifier of the imaging information; if it is determined that the identifier of the imaging information is included, the imaging information is parsed, and it is further determined whether the image data stream includes an identifier of the original image processing information; and/or if it is determined that the identifier of the imaging information is not included, then it is further determined whether the image data stream includes an identifier of the original image processing information; if it is determined that the identifier of the original image processing information is included, then the original image processing information is parsed, and processing is performed on the image data; if it is determined that the identifier of the original image processing information is not included, processing is performed on the image data.

After the image data is processed, it is determined whether the present processing causes a change in the basic image information; if it is determined that a change exists in the basic image information, then target basic image information after the change is written into the image data stream, and it is further determined whether the present processing causes a change in the imaging information; if it is determined that no change exists in the basic image information, it is further determined whether the present processing causes a change in the imaging information; if it is determined that a change exists in the imaging information, then target imaging information after the change is written into the image data stream, and the corresponding image processing information generated in the present processing is written into the image data stream; if it is determined that no change exists in the imaging information, the corresponding image processing information generated in the present processing is written into the image data stream; then the target image data obtained in the present processing is written into the image data stream, to obtain a target image data stream after the updating, and the target image data stream is output.

### Embodiment 9

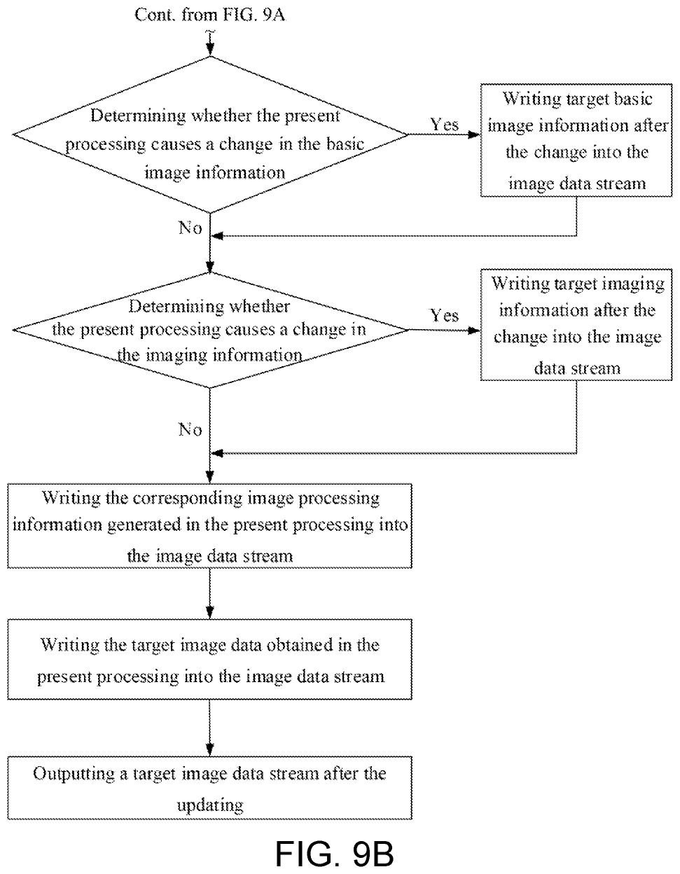

FIG. 10 is a schematic structural diagram of an image processing apparatus 1000 according to an embodiment of the present application. In an implementation, reference is made to FIG. 10, where the image processing apparatus 1000 may include:
an acquiring unit 1001, configured to acquire an image data stream; and
a processing unit 1002, configured to process the image data stream according to an image processing instruction, determine or generate corresponding image processing information, and obtain a target image.

In an implementation, the image data stream includes image data.

The processing unit 1002 is specifically configured to process the image data according to the image processing instruction to obtain target image data, and determine or generate the corresponding image processing information.

In an implementation, the image data stream includes basic image information.

The processing unit 1002 is specifically configured to determine whether the processing causes a change in the basic image information;
if it is determined that a change exists in the basic image information, determine or generate target basic image information, update the image data stream based on the target basic image information, the target image data and the image processing information, to obtain a target image data stream, and obtain the target image according to the target image data stream; and/or
if it is determined that no change exists in the basic image information, update the image data stream based on the target image data and the image processing information, to obtain a target image data stream, and obtain the target image according to the target image data stream.

In an implementation, the image processing information includes at least one of the following features:
the image processing information, in the target image data stream, is located between the target basic image information and the target image data;
the image processing information, in the target image data stream, is located between the basic image information and the target image data.

In an implementation, the image data stream further includes an identifier of imaging information.

The processing unit 1002 is specifically configured to determine whether the processing causes a change in the imaging information;
if it is determined that a change exists in the imaging information, determine or generate target imaging information, and update the image data stream based on the target basic image information, the target imaging information, the target image data and the image processing information; and/or
if it is determined that no change exists in the imaging information, update the image data stream based on the target basic image information, the target image data and the image processing information.

In an implementation, the target imaging information and the image processing information, in the target image data stream, are located between the target basic image information and the target image data, and the target imaging information is located before the image processing information; and

both the imaging information and the image processing information, in the target image data stream, are located between the target basic image information and the target image data, and the imaging information is located before the image processing information.

In an implementation, the image processing apparatus 1000 further includes an adding unit 1003.

The adding unit 1003 is configured to: if the image data stream includes original image processing information, add the image processing information to the original image processing information in the image data stream.

In an implementation, the original image processing information includes a processing-reversible identifier, and the apparatus further includes an eliminating unit 1004.

The eliminating unit 1004 is configured to: if the processing-reversible identifier indicates reversible processing, eliminate the image data from the target image data stream.

In an implementation, the basic image information includes at least one of the following:

a length of the basic image information, a type identifier of the image data, a length of the image data, a width of the image data, a color space of the image data, a bit width of the image data, or a storage mode of the image data.

In an implementation, the image processing information includes at least one of the following:

a length of the image processing information, a processing identifier, a processing-reversible identifier, processing description type information, a prior-to-processing data preservation identifier, or the image data.

The image processing apparatus 1000 shown in the embodiment of the present application can execute the technical solution of the image processing method in the foregoing embodiments. Implementation principles and beneficial effects thereof are similar to implementation principles and beneficial effects of the image processing method, and reference can be made to the implementation principles and the beneficial effects of the image processing method, and details will not be described herein again.

### Embodiment 10

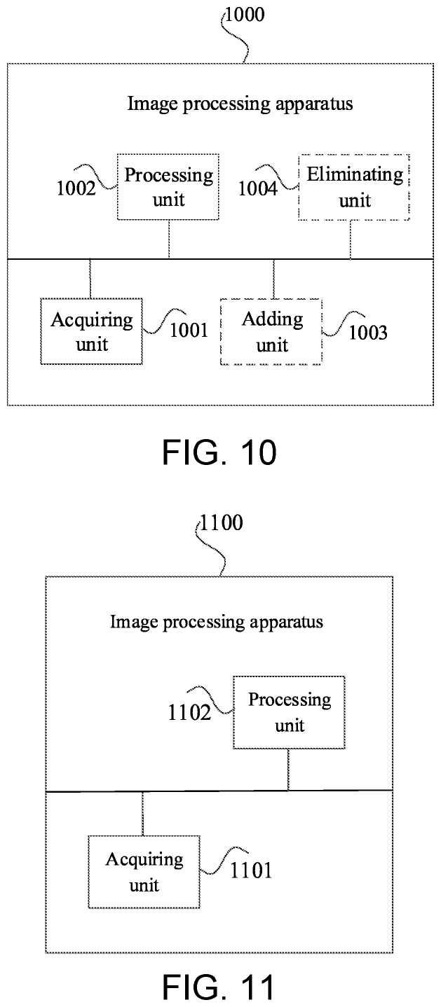

FIG. 11 is a schematic structural diagram of another image processing apparatus 1100 according to an embodiment of the present application. In an implementation, reference is made to FIG. 11, where the image processing apparatus 1100 may include:
an acquiring unit 1101, configured to acquire an image data stream, where the image data stream includes image data and basic image information; and
a processing unit 1102, configured to process the image data according to an image processing instruction, and determine or generate target basic image information, to update the image data stream, and obtain a target image.

In an implementation, the processing unit 1102 is specifically configured to: process the image data according to the image processing instruction to obtain target image data, and determine or generate corresponding image processing information; update the image data stream based on the target basic image information, the target image data and the image processing information, to obtain a target image data stream, and obtain the target image according to the target image data stream.

In an implementation, if the image data stream further includes an identifier of imaging information, the processing unit 1102 is specifically configured to determine whether the processing causes a change in the imaging information; if it is determined that a change exists in the imaging information, determine or generate target imaging information, and update the image data stream based on the target basic image information, the target imaging information, the target image data and the image processing information; and/or if it is determined that no change exists in the imaging information, update the image data stream based on the target basic image information, the target image data and the image processing information.

In an implementation, the target imaging information and the image processing information, in the target image data stream, are located between the target basic image information and the target image data, and the target imaging information is located before the image processing information; and

both the imaging information and the image processing information, in the target image data stream, are located between the target basic image information and the target image data, and the imaging information is located before the image processing information.

In an implementation, the imaging information includes at least one of the following:

a length of the imaging information, a shutter time of an imaging device, photo-sensibility of the imaging device, an aperture of the imaging device, a focal length of the imaging device, gyroscope information of the imaging device, an acceleration of the imaging device, geographic location information of the imaging device, or image rotation angle information of the imaging device.

The image processing apparatus 1100 shown in the embodiment of the present application can execute the technical solution of the image processing method in the foregoing embodiments. Implementation principles and beneficial effects thereof are similar to implementation principles and beneficial effects of the image processing method, and reference can be made to the implementation principles and the beneficial effects of the image processing method, and details will not be described herein again.

An embodiment of the present application further provides an intelligent terminal. The intelligent terminal includes a memory and a processor, where a program for processing image data is stored in the memory, and the program for processing the image data, when executed by the processor, implements the steps of the image processing method in any of the above-mentioned embodiments.

An embodiment of the present application further provides a computer readable storage medium in which a program for processing image data is stored, where the program for processing the image data which, when executed by a processor, implements the steps of the image processing method in any of the above-mentioned embodiments.

In the embodiments of the intelligent terminal and the computer readable storage medium provided in the embodiments of the present application, all the technical features in the embodiments of the above-mentioned image processing methods are included, and expansion and explanation content of the specification is basically the same as that of various embodiments of the above-mentioned methods, which will not be repeated herein.

An embodiment of the present application further provides a computer program product, and the computer program product includes computer program codes which, when running in a computer, cause the computer to execute the methods in the above-described various possible implementations.

An embodiment of the present application further provides a chip, including a memory and a processor, where the memory is configured to store a computer program, and the processor is configured to call and run the computer program from the memory, causing a device equipped with the chip to execute the methods in the above-described various possible implementations.

It can be understood that the above-mentioned scenarios are only used as examples and do not constitute a limitation on application scenarios of the technical solutions provided in the embodiments of the present application, and the technical solutions of the present application may also be applied to other scenarios. For example, persons of ordinary skill in the art would know that with the evolution of system architecture and the emergence of new service scenarios, the technical solutions provided in the embodiments of the present application are also applicable to similar technical problems.

The serial numbers of the foregoing embodiments in the present application are only for description and do not represent the superiority of the embodiments.

Steps in the methods of the embodiments of the present application may be adjusted sequentially, merged and deleted according to actual requirements.

Units in the device of the embodiments of the present application may be merged, divided, and deleted according to actual requirements.

In the present application, the same or similar term concepts, technical solutions and/or application scenario descriptions are generally described in detail only at the first occurrence, and when reoccurring later, they are generally not repeated and elaborated for the sake of conciseness. In understanding contents such as the technical solutions of the present application, etc., for the same or similar term concepts, technical solutions and/or application scenario descriptions, etc., which are not described in detail afterward, reference may be made to previous relevant detailed description thereof.

In the present application, the description of each embodiment has its own focus, and for a part which is not detailed or recorded in a certain embodiment, reference may be made to relevant description of other embodiments.

Various technical features of the technical solutions in the present application may be combined arbitrarily, and for the sake of brevity of description, the various technical features in the above-mentioned embodiments have not been described in all possible combinations, however, as long as there is no contradiction in the combinations of these technical features, they should all be considered to fall within the scope of the recordings in the present application.

Through the description of the above implementations, those skilled in the art can clearly understand that the above-mentioned methods in the embodiments may be implemented by means of software plus a necessary common hardware platform, and certainly by hardware, but the former is a better implementation in most cases. Based on such understanding, the technical solutions of the present application in essence, or a part thereof contributing to the existing technology may be embodied in a form of a software product. The computer software product is stored in one of the above storage media (e.g., a ROM/RAM, a magnetic disk, an optical disk), including several instructions to cause a terminal device (which may be a mobile phone, a computer, a server, a controlled terminal, a network device, or the like) to execute the methods of various embodiments in the present application.

The above-mentioned embodiments may be implemented wholly or in part by software, hardware, firmware, or any combination thereof. When the above-mentioned embodiments are implemented using software, all or part of them may be implemented in the form of a computer program product. The computer program product includes one or more computer instructions. When the computer program instructions are loaded and executed in a computer, all or part of the processes or functions described in the embodiments of the present application are generated. The computer may be a general-purpose computer, a special-purpose computer, a computer network, or other programmable apparatuses. The computer instructions may be stored in a computer-readable storage medium, or may be communicated from one computer-readable storage medium to another computer-readable storage medium. For example, the computer instructions may be communicated from one website, computer, server, or data center to another website, computer, server or data center in a wired (e.g., coaxial cables, optical fibers, digital subscriber lines) or wireless (e.g., infrared, radio, microwave, etc.) manner. The computer-readable storage medium may be any available medium that can be accessed by a computer, or may be a data storage device integrated with one or more available media, such as a server or a data center. The available medium may be a magnetic medium (for example, a floppy disk, a hard disk, or a magnetic tape), an optical medium (for example, a DVD), a semiconductor medium (for example, a solid state disk (SSD)) or the like.

The above are only preferred embodiments of the present application, and are not intended to limit the patent scope of the present application. Equivalent structures or equivalent flow transformations made by using the contents of the specification and drawings of the present application, or direct or indirect applications in other related technical fields, are all equally included in the patent protection scope of the present application.

What is claimed is:

1. An image processing method, comprising:
S1: acquiring an image data stream;
S2: processing the image data stream according to an image processing instruction, determining or generating image processing information, and obtaining a target image.

2. The method according to claim 1, wherein the image data stream comprises image data, and S2 comprises:
processing the image data according to the image processing instruction to obtain target image data, and determining or generating the image processing information.

3. The method according to claim 2, wherein the image data stream comprises basic image information, and S2 comprises:
determining whether the processing causes a change in the basic image information;
if it is determined that the change exists in the basic image information, determining or generating target basic image information, updating the image data stream based on the target basic image information, the target image data and the image processing information, to obtain a target image data stream, and obtaining the target image according to the target image data stream; and/or
if it is determined that no change exists in the basic image information, updating the image data stream based on the target image data and the image processing information, to obtain the target image data stream, and obtaining the target image according to the target image data stream.

4. The method according to claim 3, wherein the image processing information comprises at least one of following features:
the image processing information, in the target image data stream, is located between the target basic image information and the target image data;
the image processing information, in the target image data stream, is located between the basic image information and the target image data.

5. The method according to claim 3, wherein the image data stream further comprises an identifier of imaging information, wherein the updating the image data stream based on the target basic image information, the target image data and the image processing information comprises:
determining whether the processing causes the change in the imaging information;
if it is determined that the change exists in the imaging information, determining or generating target imaging information, and updating the image data stream based on the target basic image information, the target imaging information, the target image data and the image processing information; and/or
if it is determined that no change exists in the imaging information, updating the image data stream based on the target basic image information, the target image data and the image processing information.

6. The method according to claim 5, wherein the target imaging information and the image processing information, in the target image data stream, are located between the target basic image information and the target image data, and the target imaging information is located before the image processing information;
both the imaging information and the image processing information, in the target image data stream, are located between the target basic image information and the target image data, and the imaging information is located before the image processing information.

7. The method according to claim 3, further comprising:
if the image data stream comprises original image processing information, adding the image processing information to the original image processing information in the image data stream.

8. The method according to claim 7, wherein the original image processing information comprises a processing-reversible identifier, and the method further comprises:
if the processing-reversible identifier indicates reversible processing, eliminating the image data from the target image data stream.

9. The method according to claim 3, wherein the basic image information comprises at least one of the following:
a length of the basic image information, a type identifier of the image data, a length of the image data, a width of the image data, a color space of the image data, a bit width of the image data, or a storage mode of the image data.

10. The method according to claim 1, wherein the image processing information comprises at least one of the following:
a length of the image processing information, a processing identifier, a processing-reversible identifier, processing description type information, a prior-to-processing data preservation identifier, or image data.

11. An image processing method, comprising:
S10: acquiring an image data stream, wherein the image data stream comprises image data and basic image information;
S20: processing the image data according to an image processing instruction, and determining or generating target basic image information, to update the image data stream, and obtaining a target image.

12. The method according to claim 11, wherein S20 comprises:
processing the image data according to the image processing instruction to obtain target image data, and determining or generating image processing information;
updating the image data stream based on the target basic image information, the target image data and the image processing information, to obtain a target image data stream, and obtaining the target image according to the target image data stream.

13. The method according to claim 12, wherein if the image data stream further comprises an identifier of imaging information, wherein the updating the image data stream based on the target basic image information, the target image data and the image processing information comprises:
determining whether the processing causes a change in the imaging information;
if it is determined that the change exists in the imaging information, determining or generating target imaging information, and updating the image data stream based on the target basic image information, the target imaging information, the target image data and the image processing information; and/or
if it is determined that no change exists in the imaging information, updating the image data stream based on the target basic image information, the target image data and the image processing information.

14. The method according to claim 13, wherein the target imaging information and the image processing information, in the target image data stream, are located between the target basic image information and the target image data, and the target imaging information is located before the image processing information;
both the imaging information and the image processing information, in the target image data stream, are located between the target basic image information and the target image data, and the imaging information is located before the image processing information.

15. The method according to claim 13, wherein the imaging information comprises at least one of the following:
a length of the imaging information, a shutter time of an imaging device, photo-sensibility of the imaging device, an aperture of the imaging device, a focal length of the imaging device, gyroscope information of the imaging device, an acceleration of the imaging device, geographic location information of the imaging device, or image rotation angle information of the imaging device.

16. An intelligent terminal, comprising: a memory and a processor, wherein an image processing program is stored in the memory, and the image processing program, when executed by the processor, causes the processor to:
acquire an image data stream;
process the image data stream according to an image processing instruction, determining or generating image processing information, and obtaining a target image.

17. The terminal according to claim 16, wherein the image data stream comprises image data, and the processor is further caused to:
process the image data according to the image processing instruction to obtain target image data, and determine or generate the image processing information.

18. An intelligent terminal, comprising: a memory and a processor, wherein an image processing program is stored in the memory, and the image processing program, when executed by the processor, implements steps of the image processing method as described in claim 11.

19. A non-transitory readable storage medium, storing a computer program, wherein the computer program, when executed by a processor, implements steps of the image processing method as described in claim 1.

20. A non-transitory readable storage medium, storing a computer program, wherein the computer program, when executed by a processor, implements steps of the image processing method as described in claim 11.
